(19) United States
(12) Patent Application Publication
(10) Pub. No.: US 2014/0164944 A1
(43) Pub. Date: Jun. 12, 2014

(54) SYSTEM AND METHOD FOR DERIVING MOBILE APPLICATIONS FROM ENTERPRISE-BASED APPLICATIONS

(71) Applicant: Georgia Tech Research Corporation, Atlanta, GA (US)

(72) Inventors: Raghupathy Sivakumar, Atlanta, GA (US); Sandeep Kukumanu, Atlanta, GA (US); Cheng-Li Tsao, Atlanta, GA (US)

(73) Assignee: Georgia Tech Research Corporation, Atlanta, GA (US)

(21) Appl. No.: 13/956,056

(22) Filed: Jul. 31, 2013

Related U.S. Application Data
(60) Provisional application No. 61/677,516, filed on Jul. 31, 2012.

(51) Int. Cl. G06F 3/0484

(52) U.S. Cl. CPC G06F 3/0484
USPC 715/746

(57) ABSTRACT

The present invention is a system and method for mobilization of enterprise-based applications for mobile devices. In an aspect, the system and method derives an enterprise-based application for use on a mobile device through transformation of the user interface from an existing enterprise-based application while maintaining the functionality of the enterprise-based application. In an aspect, a mobile application derivation system transforms the enterprise-based application through implementing mechanisms that can carry over client-side logic while applying transformations. In another aspect, the mobile application derivation systems can deliver mobile friendly user interfaces (UI) and modified workflows. In another aspect, the mobile application derivation system provides fast transformations while dealing with application dynamics (i.e., changes and updates with the enterprise-based application).

### CLAIM OF PRIORITY

This application claims priority from U.S. Provisional Patent Application No. 61/677,516 filed on Jul. 31, 2012, which is relied upon and incorporated herein in its entirety by reference.

### STATEMENT AS TO RIGHTS TO INVENTIONS MADE UNDER FEDERALLY SPONSORED RESEARCH AND DEVELOPMENT

This invention was made with Government support under Grant No. CNS-1017234, awarded by the National Science Foundation. The Government has certain rights in this invention.

### BACKGROUND OF THE INVENTION

1. Technical Field

The present invention is in the technical field of the mobilization of computer based applications.

2. Related Art

With the rapid adoption of mobile devices such as smartphones and tablets, there is increased pressure on mobilizing applications traditionally consumed on enterprises servers, personal computers (PC) and their equivalents. Such applications can range from consumer applications like MS Word and Intuit Quicken to enterprise applications like SAP CRM and PeopleSoft.

There are two broad categories of solutions that exist today. The first solution is to develop the mobile application corresponding to the original enterprise application from scratch. Such development may be done natively or using a platform such as a Mobile Enterprise Application Platform (MEAP). MEAPs are platforms that can be used by enterprises to develop mobile applications by typically providing data connectors to backend data elements that can be used in mobile application development. MEAPs allow for cross platform development, where the mobile application is developed only once, and the MEAPs provide platform specific instances of the mobile application. The MEAP solution results in the mobile application having a friendlier user-experience (UX), but requires intensive effort and incurs considerable cost and time.

The second solution is to run the original application on the enterprise server or PC computer and providing a “window” into that application on the mobile device through a remote computing protocol such as RDP (Microsoft) or ICA (Citrix). Such a solution requires minimal effort in terms of cost and time, but suffers drastically in terms of the UX provided to the user. Since the original application was built for consumption on a PC, the UX when consumed from a mobile device is dismal.

Therefore, there is a need for a system and method to develop and modify enterprise-based and PC-based applications for use with mobile devices in a desirable UX while keeping costs and time relatively low.

### SUMMARY OF INVENTION

The present invention is a system and method for mobilization of enterprise and PC-based applications for mobile devices. In an aspect, the system and method derives an enterprise/PC-based application for use on a mobile device through transformation of the user interface (i.e., the views of the enterprise/PC-based application) from the existing enterprise/PC application to a user interface or view on the mobile device application while maintaining the functionality of the enterprise/PC application.

In an aspect, the mobile application derivation system transforms the enterprise/PC application through implementing mechanisms that can carry over client-side logic while applying transformations. In another aspect, the mobile application derivation systems can deliver mobile friendly user interfaces (UI) and modified workflows. In another aspect, the mobile application derivation system provides fast transformations while dealing with application dynamics (i.e., changes and updates with the PC based application).

In an aspect, application derivation through transformations poses three advantages compared to MEAP solutions: (1) there is no recreation of logic using the transformation process; (2) no changes are needed on the backend system that host the PC application; and (3) the transformation process does not intrude into the security and IT policies of the backend system.

These and other objects and advantages of the invention will become apparent from the following detailed description of the preferred embodiment of the invention.

Both the foregoing general description and the following detailed description are exemplary and explanatory only and are intended to provide further explanation of the invention as claimed. The accompanying drawings are included to provide a further understanding of the invention and are incorporated in and constitute part of this specification, illustrate several embodiments of the invention, and together with the description serve to explain the principles of the invention.

### BRIEF DESCRIPTION OF THE DRAWINGS

FIG. 1 is a schematic representation of a mobile application derivation system for use with an enterprise application server and a mobile device according to an aspect.

FIG. 2 is a schematic representation of a mobile application derivation system for use with an enterprise application server and a mobile device according to an aspect.

FIG. 3 is a schematic representation of a mobile application derivation system of FIGS. 1 and 2.

FIG. 4 is a schematic representation of an enterprise application server of FIGS. 1 and 2.

FIG. 5 is a schematic view of a representation the mobile device of FIGS. 1 and 2.

FIG. 6 is box diagram of a transformation application according to an aspect.

FIG. 7 is a schematic representation of a method carried out by a proxy module according to an aspect.

FIG. 8 is a schematic representation of a method carried out by an extract module according to an aspect.

FIG. 9 is a schematic representation of a method carried out by a virtualize module according to an aspect.

FIG. 10 is a schematic representation of a method carried out by a classify module according to an aspect.

FIG. 11 is a flow diagram of another method carried out by a classify module according to an aspect.

FIG. 12 is a flow diagram of a portion of the method of FIG. 11.

FIG. 13 is a flow diagram of a portion of the method of FIG. 11 according to an aspect.

FIG. 14 is a flow diagram of a portion of the method of FIG. 11 according to an aspect.

FIG. 15 is a flow diagram of a portion of the method of FIG. 11 according to an aspect.

FIG. 16 is a flow diagram of a portion of the method of FIG. 11 according to an aspect.

FIG. 17 is a flow diagram of a portion of the method of FIG. 11 according to an aspect.

FIG. 18 is a flow diagram of a portion of the method of FIG. 11 according to an aspect.

FIG. 19 is a block diagram of transformations performed by a transform module according to an aspect.

FIGS. 20-21 are schematic representations of a focus transformation performed by a transform module according to an aspect.

FIG. 22 is a schematic representation of a Contextualize transformation performed by a transform module according to an aspect.

FIG. 23 is a schematic representation of a transformation performed by a transform module according to an aspect.

FIG. 24 illustrates examples of the visual views provided by a deliver and render module according to an aspect.

FIG. 25 is schematic representation of a visual editor utilized by the specify module according to an aspect.

FIG. 26 is a schematic representation of a view editor tool utilized by the specify module according to an aspect.

### DETAILED DESCRIPTION OF THE EMBODIMENTS

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. To the extent necessary to understand or complete the disclosure of the present invention, all publications, patents, and patent applications mentioned herein are expressly incorporated by reference therein to the same extent as though each were individually so incorporated.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes [symbol] from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. In addition, the present methods and systems may be implemented by centrally located servers or cloud services. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, computers and components found in cloud services, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

The methods and systems that have been introduced above, and discussed in further detail below, have been and will be described as comprised of units. One skilled in the art will appreciate that this is a functional description and that the respective functions can be performed by software, hardware, or a combination of software and hardware. A unit can be software, hardware, or a combination of software and hardware. In one exemplary aspect, the units can comprise a computer. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, cloud services, mobile devices (e.g., smart phones, tablets, and the like) and multiprocessor systems. Additional examples comprise set top boxes, programmable consumer electronics, network PCs, minicomputers, mainframe computers, enterprise servers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

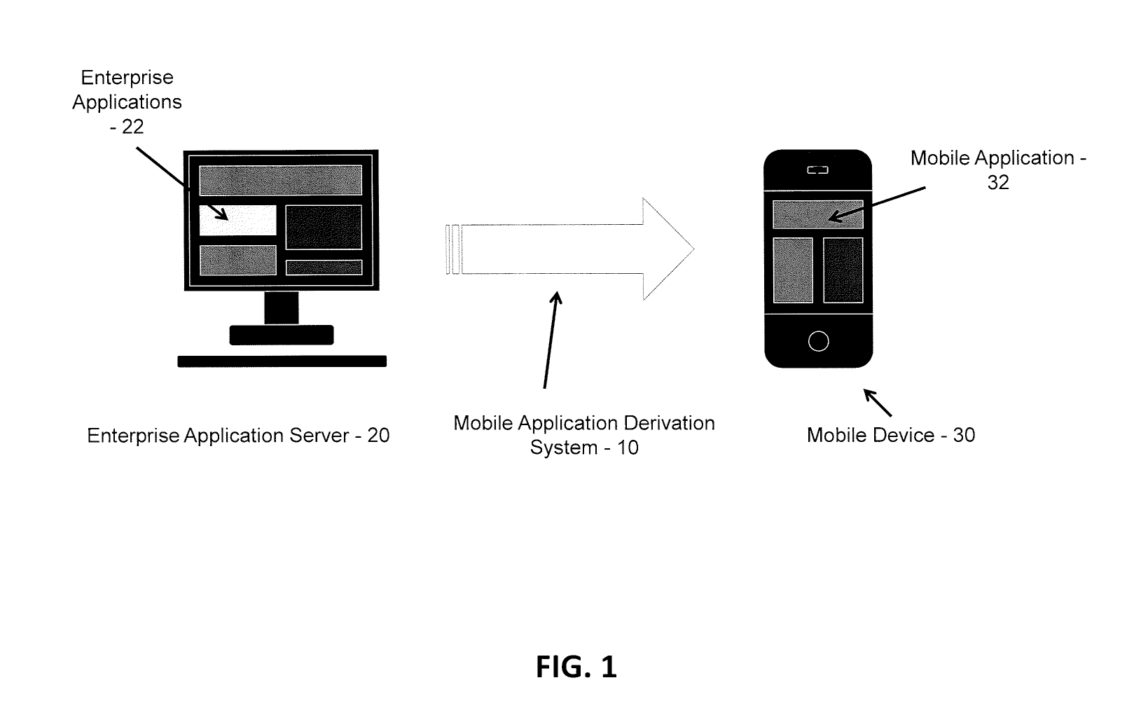

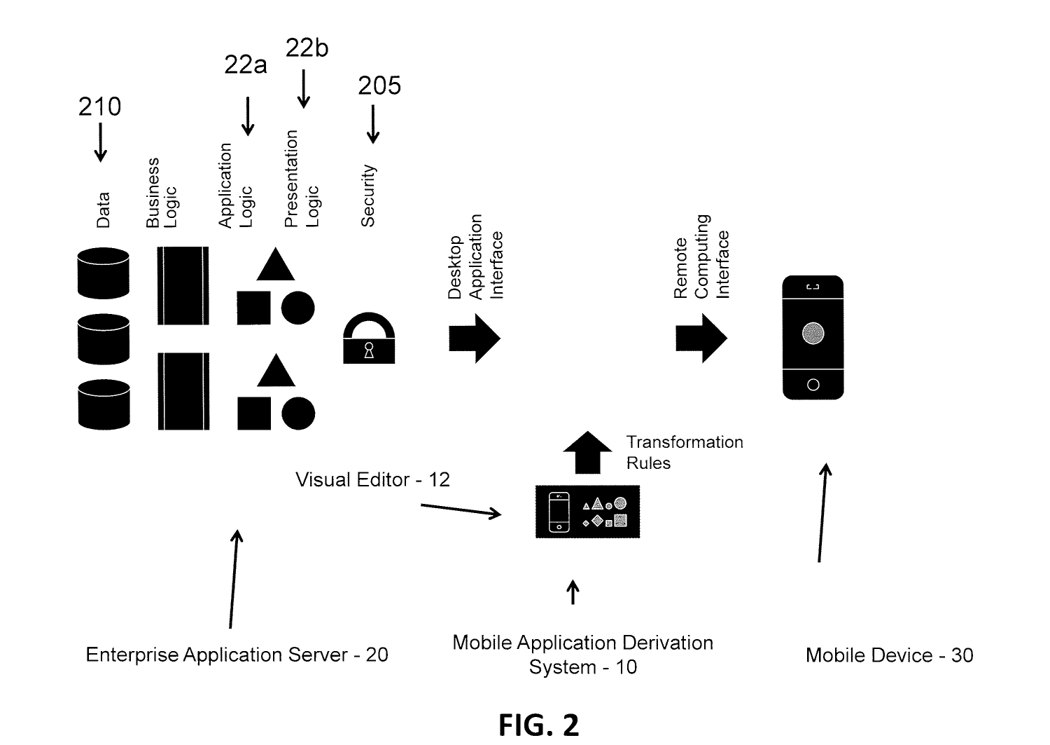

Referring to FIGS. 1 and 2, the present invention is directed to a mobile application derivation system 10. According to an aspect, the mobile application derivation system 10 is configured to communicate with an enterprise application server 20 and a mobile device 30. More specifically, the mobile application derivation system 10 is configured to transform an enterprise application 22 of the enterprise application server 20 into a mobile application 32 for use on a mobile device 30. In an aspect, the mobile application derivation system 10 can provide means (e.g., a visual editor 12 as shown in FIG. 2) for an administrator to create transformation rules for layout types of views/user interfaces (UIs) from the enterprise application 22. The transformation rules will then transform the UIs or application views from the enterprise application 22 for use with the mobile application 32 on the mobile device 30.

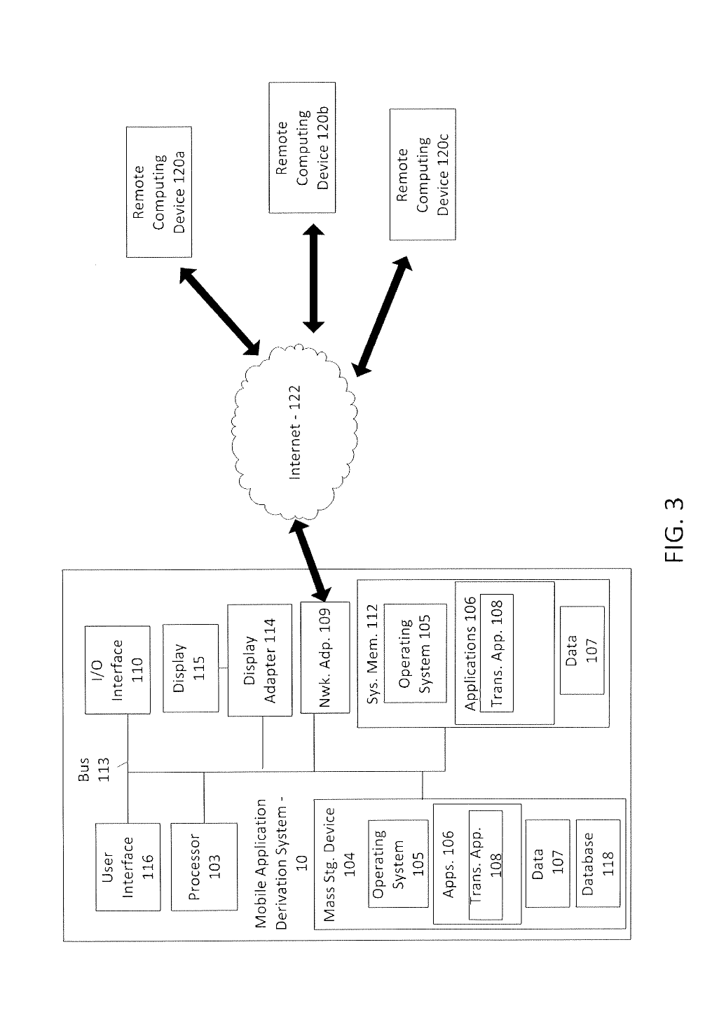

As shown in FIGS. 1 and 2, the mobile application derivation system 10 can take the form of a cloud service 10. Further, one skilled in the art will appreciate that the systems and methods utilized by the mobile application derivation system 10 disclosed herein can be implemented via a general-purpose computing device in the form of a computer 10 as shown in FIG. 3. Referring to FIG. 3, the mobile application derivation system 10 may have several applications 106, including, but not limited to, a transformation application 108. In an aspect, the mobile application derivation system 10 and its applications 106 may utilize elements and/or modules of several nodes or servers that make up cloud services and the like. In any event, the mobile application derivation system 10 should be construed as inclusive of multiple modules, software applications, servers and other components that are separate from the enterprise application server 20 and the mobile devices 30.

The components of the mobile application derivation system 10, in addition to the applications 106 and the transformation application 108, can comprise, but are not limited to, one or more processors or processing units 103, a system memory 112, and a system bus 113 that couples various system components including the processor 103 to the system memory 112. In the case of multiple processing units 103, the system 10 can utilize parallel computing.

The system bus 113 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 113, and all buses specified in this description can also be implemented over a wired or wireless network connection and each of the subsystems, including the processor 103, a mass storage device 104, an operating system 105, applications 106, including, but not limited to, the transformation application 108, a network adapter 109, system memory 112, an Input/Output Interface 110, a display adapter 114, a display device 115, and a user interface 116. As discussed above, these components can be contained within one or more remote computing devices at physically separate locations, connected through buses of this form, in effect implementing a fully distributed system.

The mobile application derivation system 10 typically comprises a variety of computer readable media. Exemplary readable media can be any available media that is accessible by the mobile application derivation system 10 and comprises, for example and not meant to be limiting, both volatile and non-volatile media, removable and non-removable media. The system memory 112 comprises computer readable media in the form of volatile memory, such as random access memory (RAM), and/or non-volatile memory, such as read only memory (ROM). The system memory 112 typically contains data such as transformation data 107 and/or program modules such as operating system 105 and transformation application 108 that are immediately accessible to and/or are presently operated on by the processing unit 103.

In another aspect, the mobile application derivation system 10 can also comprise other removable/non-removable, volatile/non-volatile computer storage media. By way of example, FIG. 3 illustrates a mass storage device 104 which can provide non-volatile storage of computer code, computer readable instructions, data structures, including databases 118, program modules, and other data for the mobile application derivation system 10. For example and not meant to be limiting, a mass storage device 104 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 104, including by way of example, an operating system 105 and transformation application 108. Each of the operating system 105 and other applications (including the transformation application 108) (or some combination thereof) can comprise elements of the programming and the transformation application/software 108. Transformation data 107 can also be stored on the mass storage device 104. In an aspect, the data 107 can be stored in a database 118. Transformation data 107 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the mobile application derivation system 10 via an input device (not shown). Examples of such input devices comprise, but are not limited to, a keyboard, pointing device (e.g., a “mouse”), a microphone, a joystick, a scanner, tactile input devices such as gloves, and other body coverings, and the like. Further examples can include image capturing devices, such as, but not limited to, optical coherence tomography capturing devices, fundus cameras, scanning laser ophthalmoscope, and other devices used to capture images and other information related to the monitoring and examination of eyes. These and other input devices can be connected to the processing unit 103 via a human machine interface 116 that is coupled to the system bus 113, but can be connected by other interface and bus structures, such as a parallel port, game port, an IEEE 1394 Port (also known as a Firewire port), a serial port, or a universal serial bus (USB), or network connection.

In yet another aspect, a display device 115 can also be connected to the system bus 113 via an interface, such as a display adapter 114. It is contemplated that the mobile application derivation system 10 can have more than one display adapter 114 and the mobile application derivation system 10 can have more than one display device 115. For example, a display device can be a monitor, an LCD (Liquid Crystal Display), or a projector. In addition to the display device 115, other output peripheral devices can comprise components such as speakers (not shown) and a printer (not shown) which can be connected to mobile application derivation system 10 via Input/Output Interface 110. Any step and/or result of the methods can be output in any form to an output device. Such output can be any form of visual representation, including, but not limited to, textual, graphical, animation, audio, tactile, and the like.

The mobile application derivation system 10 can operate in a networked environment using logical connections to one or more remote computing devices 120a,b,c. By way of example, a remote computing device can be a personal computer, portable computer, a server, a router, a network computer, a wireless connected tablet or mobile device, a peer device or other common network node, and so on. Logical connections between the computer 101 and a remote computing device 120a,b,c can be made via a local area network (LAN) and a general wide area network (WAN). Such network connections can be through a network adapter 109. A network adapter 109 can be implemented in both wired and wireless environments. Such networking environments are conventional and commonplace in offices, enterprise-wide computer networks, intranets, cellular networks and the Internet 122.

For purposes of illustration, application programs and other executable program components such as the operating system 105 are illustrated herein as discrete blocks, although it is recognized that such programs and components reside at various times in different storage components of the mobile application derivation system 10 and are executed by the data processor(s) of the computer. An implementation of transformation software 108 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Big Data Analytics techniques such as statistical analysis, data mining, machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

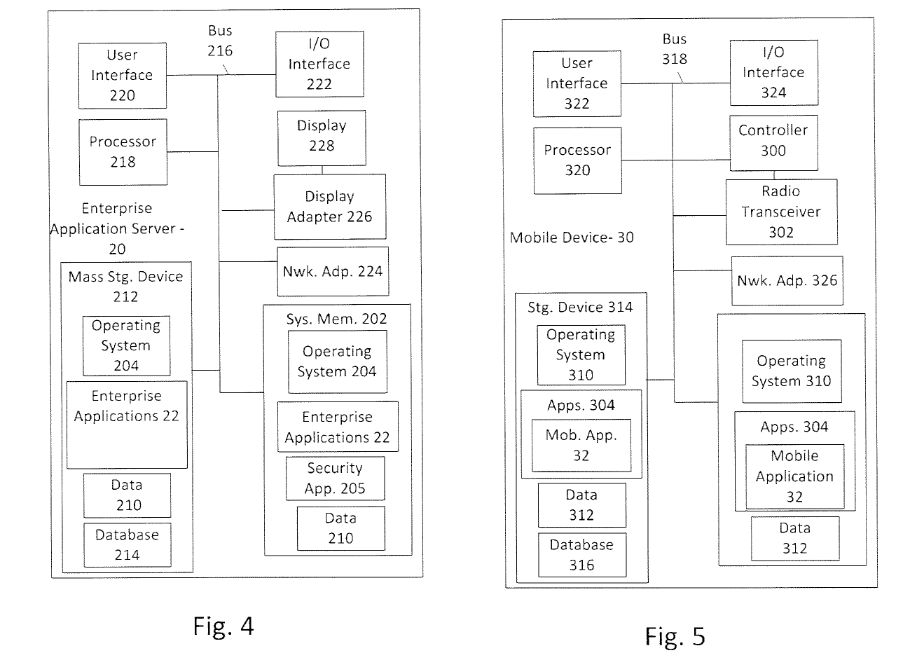

Referring to FIGS. 1-2 and 4, the mobile application derivation system 10 communicates with an enterprise application server 20. The enterprise application server 20 provides the enterprise applications 22 that the mobile application derivation system 10 transforms for use on the mobile devices 30. While FIGS. 1-2 and 4 refer to and display an enterprise application server 20 with an enterprise application 22, one skilled in the art will appreciate that the enterprise application server 20 disclosed herein can include any general-purpose computing device that hosts a given application (i.e., non-mobile application) that needs to be transformed/derived for mobile uses.

Referring to FIGS. 1-2 and 4, the enterprise application server 20 may have several applications 22. The enterprise application server 20 and its applications 22 may utilize elements and/or modules of several nodes or servers that make up cloud services and the like. In any event, the mobile enterprise application server 20 should be construed as inclusive of multiple modules, software applications, servers and other components that are separate from the mobile application derivation system 10 and the mobile devices 30.

The enterprise application server 20 may include a system memory 202 configured to store an operating system 204 and various enterprise applications 22 (which can be comprised of application logic 22a and presentation logic 22b as shown in FIG. 2), and security applications 205. The mobile enterprise application server 20 may also include data 210 that is accessible by the applications 22. The mobile enterprise application server 20 may include a mass storage device 212, on which data 210 can be stored. In addition, the mass storage device 212 can be used for storing computer code, computer readable instructions, program modules, and various databases 214. The mass storage device 212 can be used to back up or alternatively to run the operating system 204 and/or other enterprise applications 206. The mass storage device 212 may include a hard disk, various magnetic storage devices such as magnetic cassettes or disks, solid state-flash drives, CD-ROM, DVDs or other optical storage, random access memories, and the like.

The enterprise application server 20 may include a system bus 216 that connects various components of the mobile enterprise application server 20 to the system memory 202 and to the mass storage device 212, as well as to each other. Other components of the mobile enterprise application server 20 may include one or more processors or processing units 218, a user interface 220 and an input/output interface 222 to which mobile enterprise application server 20 may connect. In addition, mobile enterprise application server 20 may include a network adapter 224 that is configured to communicate with other devices over various networks. In addition, mobile enterprise application server 20 may include a display adapter 226 that communicates with a display device 228, such as a computer monitor or other similar devices that present images and text in various formats. A system administrator can interact with the mobile enterprise application server 20 through one or more input devices (not shown), which include, but are not limited to, a keyboard, a mouse, a touch-screen, a microphone, a scanner, a joystick, and the like, via the user interface 220.

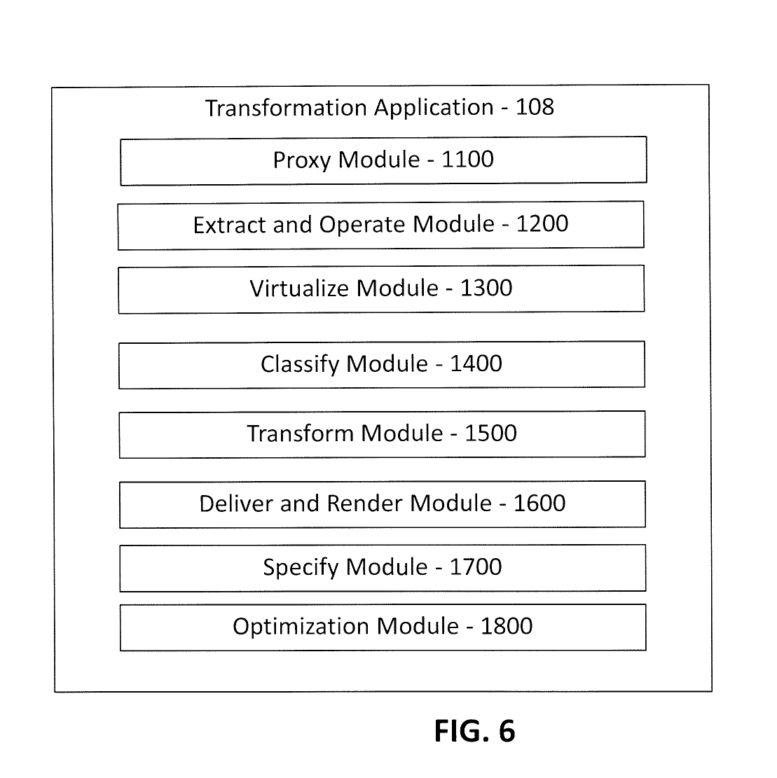

Referring to FIGS. 1-2 and 5, the mobile application derivation system 10 communicates with the mobile device 30. The mobile device 30 can include, but is not limited to, smartphones, tablets, and any other mobile device 30 that can be configured to run various applications. As discussed in more detail below, the mobile device 30 is configured to the mobile application 32 which corresponds to the enterprise application 22 that has been transformed by the mobile application derivation system 10. In an aspect, the mobile application 32 can be installed on the mobile device 30 in order to initiate and call on the mobile application derivation system 10 to initiate the derivation and transformation of the enterprise application 22, discussed in detail below. In another aspect, the mobile application 32 can be an HTNL5 client or a web-based client that does not require installation in a mobile operating system.

The mobile device 30 may have one or more software applications 304, including the mobile application 32. The mobile device 30 includes system memory 308, which can store the various applications 304, including, but not limited to, the operating system 310 of the mobile device 30 and the file transfer management application 306. In an aspect, the mobile device 30 can include a controller 300 and a radio transceiver 302 to allow wireless communication from the mobile device 30. The system memory 308 may also include data 312 accessible by the various software applications. The system memory 308 can include random access memory (RAM) or read only memory (ROM). Data 312 stored on the mobile device 30 may be any type of retrievable data. The data may be stored in a wide variety of databases, including relational databases, including, but not limited to, Microsoft Access and SQL Server, MySQL, INGRES, DB2, INFORMIX, Oracle, PostgreSQL, Sybase 11, Linux data storage means, and the like.

The mobile device 30 can include a variety of other computer readable media, including a storage device 314. The storage device 314 can be used for storing computer code, computer readable instructions, program modules, various databases 316, and other data for the mobile device 30, and the storage device 314 can be used to back up or alternatively to run the operating system 310 and/or other applications 304, including the mobile application 32. The storage device 314 may include a hard disk, various magnetic storage devices such as magnetic cassettes or disks, solid-state flash drives, CD-ROM, DVDs or other optical storage, random access memories, and the like.

The mobile device 30 may include a system bus 318 that connects various components of the mobile device 30 to the system memory 308 and to the storage device 314, as well as to each other. Other components of the mobile device 30 may include one or more processors or processing units 320, a user interface 322, and an input/output interface 324. The input/output interface 324. In addition, the mobile device 30 may include a network adapter 326 configured to communicate with other devices over various networks, including the mobile application derivation system 10. In an aspect, the combination of the controller 300 and radio transceiver 302 can be utilized to communicate with other devices over various wireless networks.

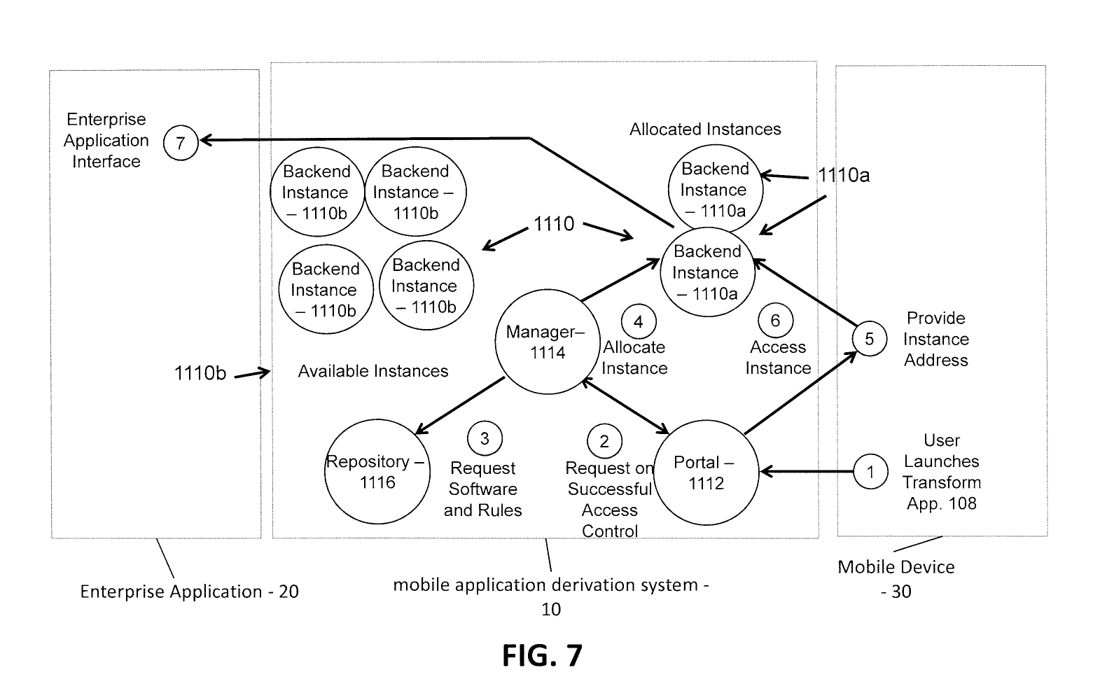

In an aspect, as illustrated in FIG. 6, the transformation application 108 of the mobile application derivation system 10 comprises several modules. In an exemplary aspect, the transformation application can include a proxy module 1100, an extract and operate module 1200, a virtualize module 1300, a classify module 1400, a transform module 1500, a deliver and render module 1600, a specify module 1700, and an optimization module 1800. The transformation application 108 can include additional modules that can assist in the transformation of an enterprise application 22 for use on a mobile device 30. In an aspect, the transformation application 108 can include these modules, or call on such modules that may be associated with other applications 104 associated with the mobile application derivation system 10.

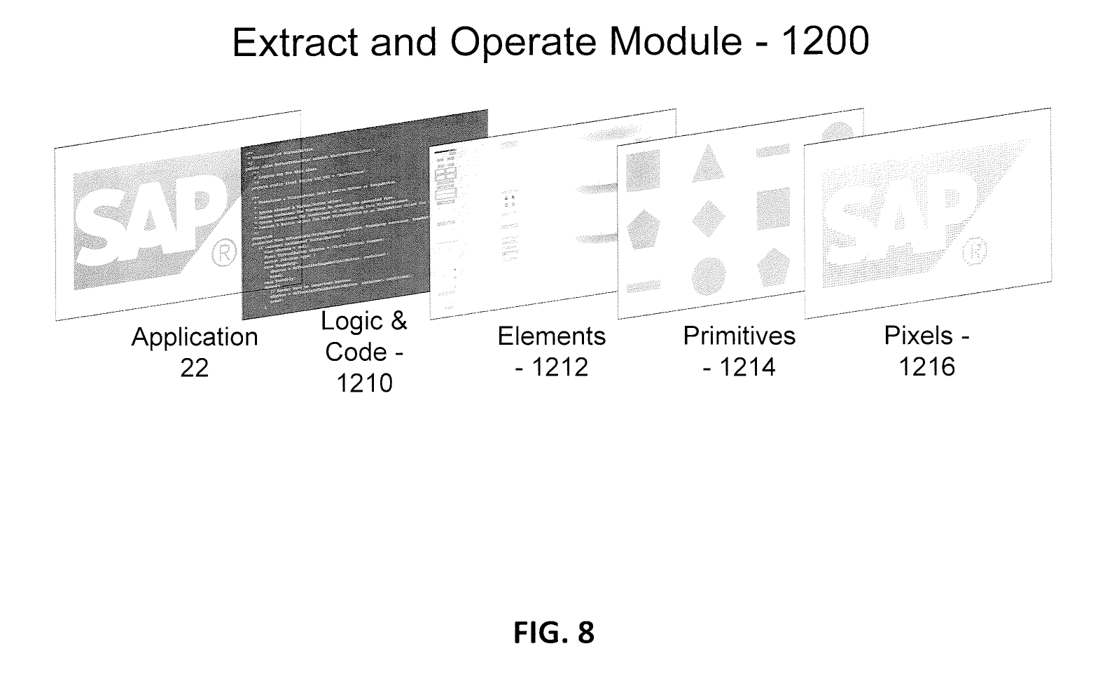

In an aspect, the proxy module 1100 assists the mobile application derivation system 10 in providing a platform with agnostic capability to host and retain logic of existing applications from the enterprise server 20 to derive the mobile application 32 for the mobile devices 30. In an aspect, the proxy module 1100, using elements of the mobile application derivation system 10, hosts the full-fledged enterprise application 22 to extract the UI information to deliver to the mobile device 30. In an aspect, the proxy module 1100 is configured to initiate and maintain backend instances 1110, as shown in FIG. 7.

In an aspect, the backend instance 1110 can be a single virtual or physical machine. The backend instance 1110 can occur on the mobile application derivation system 10 clouds or other computing devices associated with the mobile application derivation system 10. A backend instance 1110 is capable of hosting any PC application client that will be mobilized. In an aspect, the backend instance can be a hosted instance in a public cloud such as Amazon EC2, Microsoft Azure, Rackspace managed cloud or similar offerings. For security reasons the backend instance 1110 could also be part of a virtual private cloud that is accessible only from within an enterprises network boundary (e.g., Amazon Virtual Private Cloud or VPC). Alternatively the backend instance could be a hosted virtual machine (VM) in a private cloud environment of an enterprise. The backend instance can also be a physical machine or PC either publicly accessible from the Internet or accessible only within the enterprise network boundary using a VPN if necessary.

In an aspect, for scalability in terms of number of simultaneous users that can access the enterprise application 22, the proxy module 1100 can maintain a number of backend instances 1110 (as shown in FIG. 7) that can either be in active states 1110a or in-active states 1110b. An active state backend instance 1110a is one, which is actively being used to host an application on which a mobile device 30 calls upon. An in-active instance 1110b is one that is not currently being used.

The proxy module 1110, through the use of a portal 1112, a manager 1114, and a repository 1116, maintains a pool of active backend instances 1110a and in-active backend instances 1110b based on requirements of the customer. As shown in FIG. 7, when a mobile device 30 calls upon the mobile application 32, the portal 1112 is called upon (shown at step 1 in FIG. 7). In an aspect, the portal 1112 performs authentication and authorization of the mobile device 30 for use of the application 22 on the enterprise server 20. In an aspect, the portal 1112 can authenticate a mobile device 30 based on credentials provided by the mobile device 30. The credentials can be automatically supplied by the mobile device 30, or the portal can call upon the user of the mobile device 30 to provide credentials (e.g., login authorization information). Once the credentials have been sufficiently authenticated, the portal 1112 can then call upon the manager 1114 to create a session for accessing the enterprise application 22 through the mobile application derivation system 10 (step 2).

Once the portal 1112 has requested access, the manager 1114 can call upon repository 1116 (step 3). In an exemplary aspect, the manager 1114 requests software and rules from the repository 1116. The repository 1116 is configured to maintain software components that need to be loaded in each backend instance 1110a used during environment preparation, discussed in more detail below. The software components include executable and configuration files, including fingerprints, layout types, and transformation rules, discussed in more detail below, for each application 22 to be transformed. In an aspect, the repository 1116 can store the software components within databases and other storage means.

Upon receiving the needed software components and rules, the manager 1114 can then allocate an available backend instance 1110b. (step 4). The proxy module 1110, through the manager 1114, maintains a pool of active backend instances 1110a and in-active backend instances 1110b based on requirements of the customer. If there is an inactive instance 1110b, the manager 1114 will provide access for the mobile device based upon the IP address of the mobile device 30 (step 5). The manager 1114 turns on and shuts down backend instances based on the instance management algorithm, and keeps track of the state of those instances. Once the address has been provided, the manager 1114 will provide access to the backend instance 1110 to the mobile device 30 (step 6) as well as establish a connection to the enterprise server 20 to access the enterprise application through an interface (step 7).

In an aspect, the proxy module 1110 prepares the backend instance for hosting the enterprise application 22 before providing access to the mobile device 30. Depending on the application, the backend instance 1110a can require a specific operating system. Such operating systems can include, but are not limited to, web browsers, Microsoft Windows Server, Various Linux flavors, or other known operating systems. Further, the system resources available for the backend instance such as number of CPU cores, RAM etc. can be configured depending on the application needs. In case the application requires system level authentication such as Windows active directory, LDAP, VPN, or otherwise, the authentication is performed between the backend instance and the enterprise network that hosts the application server. The application client can either be web-based or a stand-alone thick client that may or may not interact with an application server hosted in the enterprise network.

In an aspect, if the enterprise application 22 is web-based, the proxy module 1100 can run a full-fledged browser in the backend instance 1110 to host the application client 22. The mobile application derivation system 10 can handle a plurality of browsers, including, but not limited to, Firefox, Internet Explorer, Chrome, and Safari amongst others. To conserve CPU cycles and/or memory requirements, the proxy module 1100 can optionally use a headless browser that loads a web application 22 completely, but does not actually render the graphical result of loading the web application 22 on the backend instance 1110a. An example of such headless browser is the Selenium browser based on Firefox. Once the proxy module 1100 has initiated the hosting of the application 22 through a backend instance 1110a, the transformation application 108 can call upon the Extract and operate module 1200.

While the discussion below focuses on a single user using a single backend instance at any given time, the mobile application derivation system 10 is configured to allow for multiple users/mobile devices 30 using a single backend instance 1110 at a time, a single user/mobile device 30 using multiple backend instances 1110 at the same time or a combination of a number users/mobile devices 30 and a number of backend instances 1110 at the same time.

In an aspect, the manager 1114 can call upon an instance management algorithm to handle the requirements of availability and at the same time optimizes the cost of maintaining the backend instances in use. If there are no available in-active instances, it will take a long time to spin up new instances when new users request for access to mobilized applications. Cost optimization is important because an instance in the in-active state costs money while not being used by an active user.

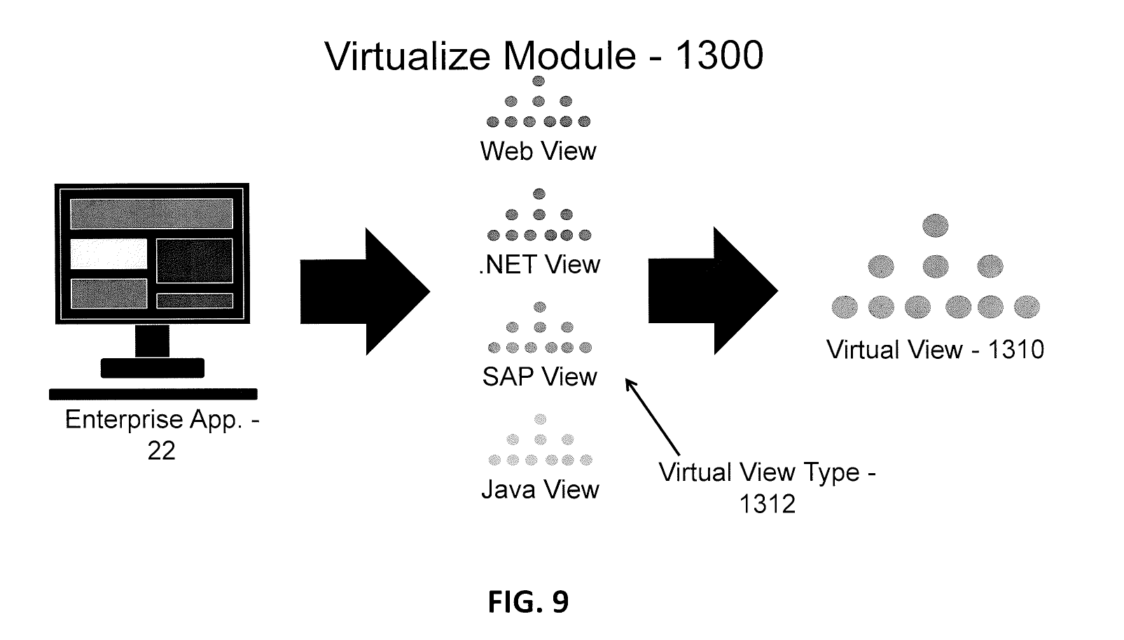

In an aspect, the extract and operate module 1200 is configured to extract user interfaces (UIs), data, and workflow elements from the enterprise application 22. In an aspect, the extract and operate module 1200 can extract the enterprise application 22 the logic and code 1210, elements 1212, primitives 1214, and pixels 1216, as shown in FIG. 8. In an aspect, when the enterprise application 22 is a web application, the extract and operate module 1200 extracts UI, data, and workflow elements from the application 22 by accessing a data structure called a Document Object Model (DOM) tree. The DOM tree is a standard data structure used for representing and interacting with HTML elements in web applications. In an aspect, the DOM tree is a cross-platform representation of elements in HTML, XHTML, and XML documents. The application programming interface (API) of DOM specifies standard attributes and methods that can be addressed and manipulated on each HTML element. For example, DOM API allows JavaScript programs to read the value attributes of input fields for data validation before submitting a form using the submit( ) method. As elements in a HTML, XHTML, or XML document are organized using a tree structure, a DOM tree is the representation of the tree structure using DOM API.

In an aspect, the extract and operate module 1200 can extract three types of attributes (e.g., properties, constituent fields, etc.) from each DOM element: a JavaScript variable, a JavaScript object, or attributes not directly stored in an HTML element.

The extract and operate module 1200 can extract a primitive JavaScript variable, such as a string or an integer, that is directly stored in a DOM element. Such attributes include but are not limited to nodeName, id, className, name, type, value, nodeValue, href, alt, title, src, checked, disabled, colspan, and rowspan.

A JavaScript object can be converted into a primitive variable or a set of primitive variables. For example, onclick is a function object, which is converted to a string.

An attribute is not directly stored in an HTML element and can be derived from the variables, objects, or functions stored in elements in the DOM tree. For example, the location of an element is derived from offsetLeft and offsetTop of the element and its offsetParent recursively. The style of an element is derived from the currentStyle object or window.getComputedStyle function depending on the browser support. The index of an element among its siblings in the DOM tree can be computed by comparing the element to all elements in the childNode element array of its parent.

In an aspect, the extract and operate module 1200 is configured to extract the UI elements of a web application whenever there is an update in its UI or data elements. The extract and operate module 1200 can be configured to monitor the webs application for updates. When an updating event occurs, the extract and operate module 1200 can be configured to extract the elements as discussed above.

In an aspect, the extract and operate module 1200 can be configured to monitor the specific events. For example, the extract and operate module 1200 can be configured to capture the beginning, progress, and ending of a page load of the entire HTML page or an inner frame in a page. In another aspect, the extract and operate module 1200 can listen to load events and progress events to detect the loading of an HTML page or an object in it. In an example, the system 10 can use nsIWebProgressListener of firefox to capture OnStateChange events to detect the progress in a page load. In addition, the extract and operate module 1200 can be configured to capture updates in an HTML element or part of the DOM tree in a web application. The updates are typically be triggered by the frontend JavaScript code of the web application. For example, the extract and operate module 1200 listens to DOMNodeInserted and DOMNodeRemoved to detect structure changes to the DOM tree, and it listens to DOMAttrModified, change, and select events to detect properties changes in any element in the DOM tree. The extract and operate module 1200 can be further configured to capture events triggered by the user actions. For example, the extract and operate module 1200 listens to keydown and mousedown events to detect mouse clicks and keystrokes, respectively. Lastly, the extract and operate module 1200 can be configured to capture events outside the scope of HTML but relevant to the web application. For example, MORPH uses the nsIObserverService of firefox to listen to file downloading events including dl-start, dl-done, dl-cancel, and dl-failed. While in the above exemplary aspect, the extract and operate module 1200 has been shown be able to monitor events specific to a Firefox web application, the same events can be captured in other browsers with no or minor variations. For example, JavaScript can be used as the language since native JavaScript API is used to access the DOM tree in most browsers, including Firefox, Chrome, Safari, and Opera. A COM-based API with a similar structure can be used to access the DOM tree of a web application in Internet Explorer.

In an aspect, the extract and operate module 1200 can be used to extract non-web UI elements that are not built with standard HTML. To extract and operate such UI elements, the accessibility framework of the underlying application platform can be used to access attributes and APIs in a similar way as web-based UI elements. Examples of such accessibility frameworks include UI Automation for .NET platform and SAP GUI Scripting for SAP platform.

Such non-web UI elements include UI elements of the browser that reside out of the scope of DOM tree. For example, the HTTP authentication dialog, the alert dialog, and the file selection dialog of a browser consists of native UI elements of the application platform on which the browser is developed. In addition, such UI elements can include UI elements built on rich-Internet application platforms, including Flash, JavaFX, and Silverlight. Also, UI elements from applications that use plug-ins or extensions in browsers and UI elements from applications built on thick-client application platforms, including .NET, SAP, Java, GTK+, Cocoa, Qt, wxWidgets, etc., can be extracted. Other UI elements can be captured by the extract and operate module 1200.

In addition to the extracting of the elements from the enterprise application 22, the extract and operate module 1200 is configured to capture and translate each user action on the derived mobile application 32 into a corresponding action for the enterprise application 22. In an aspect, the actions can include touch actions and key actions.

A touch action is translated into a mouse action on the corresponding DOM element in the web application 22. The mouse event is performed with multiple methods, which include (a) direct function invocations on the DOM element such as focus( ) and click( ), (b) firing one or a sequence of mouse events on the DOM element, and (c) a combination of both methods.

A key action is translated into an input action that sets value in the corresponding DOM element in the web application. The input action is performed with two methods: (a) direct attribute modification in the DOM element, and (b) firing one or a sequence of keystroke events on the DOM element. When a web application 22 is transformed, the Action is translated into an action on the DOM tree of the web application.

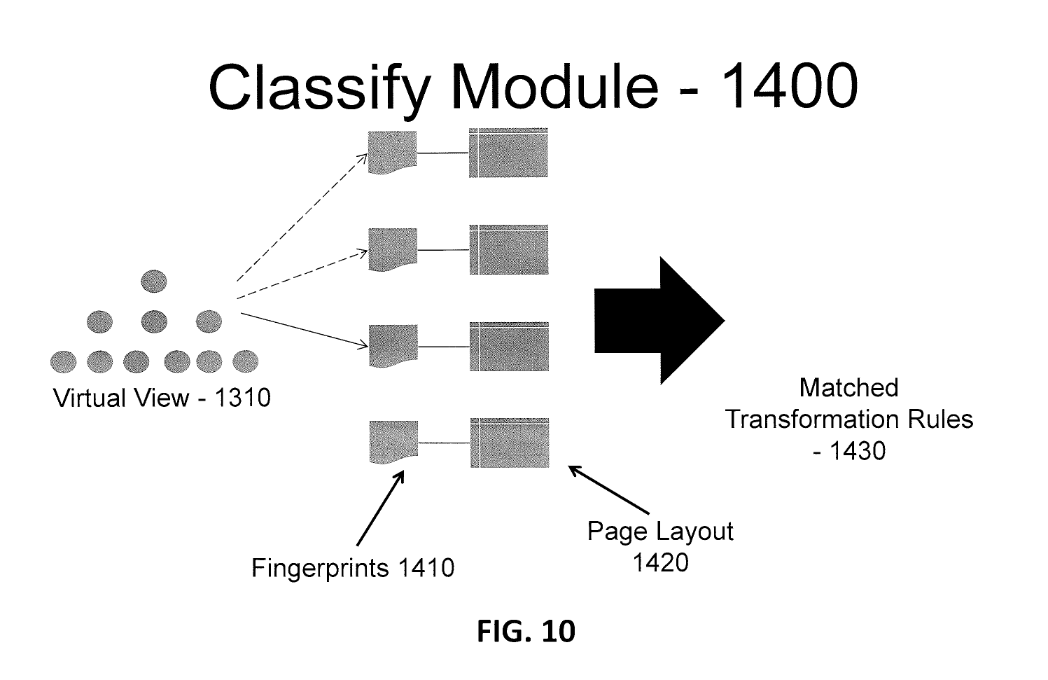

The virtualize module 1300 can be configured to provide a virtual view 1310 of a uniform representation of the UI, data, and workflow elements from the enterprise application 22 extracted by the extract and capture module 1200, as shown in FIG. 9. In an exemplary aspect, the virtualize module 1300 generates the virtual view by applying the correct view type 1312 (Web View, .NET View, SAP View, Java View etc.) which is dependent on the type of enterprise application 22.

In an aspect, the virtualize module 1300 can convert each UI, data, and workflow element extracted into a corresponding virtual element. In an aspect, the virtualize module 1300 can provide the view virtualization as described in U.S. patent application Ser. No. 13/651,593, entitled “View Virtualization and Transformations for Mobile Application”, the entirety which is herein incorporated by this reference. The created view virtualization 1310 can be in the form of a virtual view 1310, which can be utilized by the classify module 1400, described in more detail below. In an aspect, the virtual view 1310 will contain representations of all elements from the enterprise application 22. The number of virtual views 1310 created by the virtualize module 1300 is dependent on the enterprise application 22. For example, an enterprise application 22 can have a multitude of functions, resulting in numerous layouts of UIs and elements. In addition, the virtual view 1310 can be created when the mobile device 30 calls upon a specific function to be performed by the mobile application 32, which will then call upon the corresponding function to be performed by the enterprise application 22, which is currently being hosted in a backend instance 1110 as discussed above. In another aspect, the transformation application 108 can provide a native view extracted from the enterprise application 22.

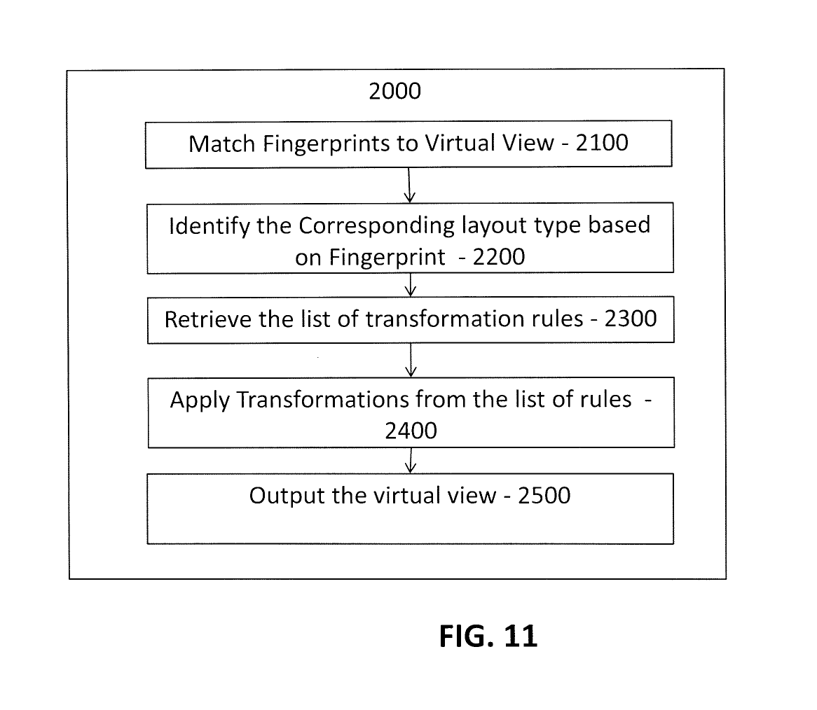

FIG. 10 provides an overview of the workflows performed by the classify module 1400 according to an aspect. In an aspect, the classify module 1400 uses fingerprints 1410, page layouts 1420 and associated transformation rules 1430 to transform the virtual view 1310 for use by the mobile application 32.

The classify module 1400 classifies the UI, data, and workflow elements as shown in the input virtual view 1310, which then dictates how the UI, data, and workflow elements are then transformed. The UI elements can be native UI elements and composite UI elements. A native UI element created from the application platform. In the context of web applications, a basic UI element is a standard HTML element, such as <div> and <a>. A composite UI element is a set of basic UI elements used jointly to form certain non-standard functionality. For example, HTML standard does not contain a dynamic drop-down list (in which the options are updated dynamically) and an auto-complete edit box. Such composite UI elements can be constructed using basic HTML elements such as <input>, <div>, and <a>.

In an aspect, the classify module 1400 can fingerprint virtual views using a flexible pattern. A fingerprint 1410 is defined as a “regular-expression” pattern of UI elements and their attributes in a page view. A “regular expression” is a sequence of characters that forms a search pattern, mainly for use in pattern matching with strings, or string matching, i.e. “find and replace”-like operations. Each fingerprint has a flexible pattern, like a regular expression used in string matching, but used in the context of UI elements. Such a flexible pattern can perform exact match or partial match to one or multiple attributes residing in one or multiple UI elements. Each fingerprint 1410 is created to characterize and classify all page views of a specific layout type 1420, and it works robustly against application dynamism.

In an example of an exemplary aspect, an application X, a content management system with page views can be structured in the following hierarchy: (1) A home page that shows a list of sites; (2) a site page that shows the site name in breadcrumb and a list of modules in this site; and (3) a module page that shows both site name and module name in the breadcrumb, and shows a list of documents stored in this module. The administrator for the application X may add any number of new sites, modules, or documents to the application. The classify module 1400 allows handling of such application dynamics by defining three fingerprints 1410 that correspond to above three layout types 1420: (1) the page title equals to “Home”; (2) the page contains one text element in an element with name “breadcrumb”; and (3) the page contains two text elements in an element with name “breadcrumb”. In other aspects, other fingerprints can be used.

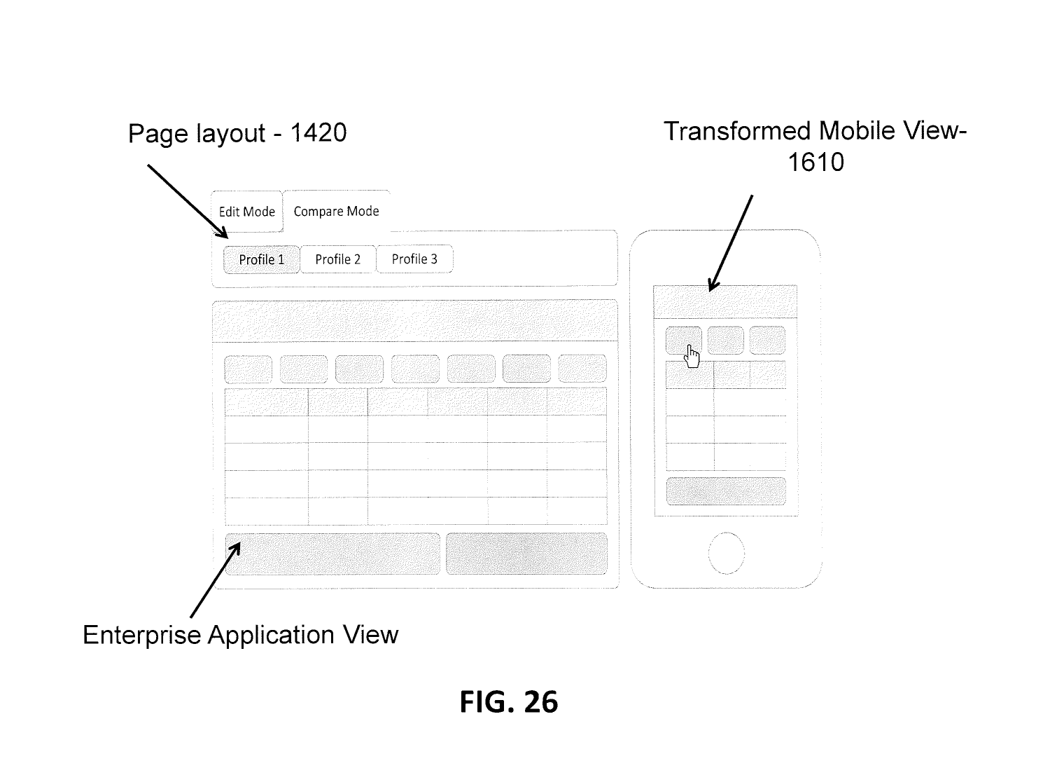

The classify module 1400 can then use each fingerprint 1410 to determine a layout type 1420 and determine a set of transformation rules 1430. The fingerprints 1410 can then be used to classify all the page views, matching a fingerprint to characterize a layout type 1420 of the page view. A layout type 1420 is a set of page views sharing the same fingerprint 1410 that can be transformed into mobile view using the same set of transformation rules 1430. The layout types 1420 can include, but are not limited to, full page views and partial page views. A Full Page View is defined as an application view that fully occupies an application window. A Partial Page View is an application view that is overlaid on top of another page view and does not fully occupy an application window. Each layout type 1420 is associated with a set of transformation rules 1430. In an aspect, the visual editor 12 (See FIGS. 2 and 26) can assist an administrator in setting up fingerprints 1410 with the corresponding page layouts 1420 and the desired transformation rules 1430.

As discussed above, the classify module 1400 utilizes transformation rules 1430. The transformation rules 1430 can be stored in the form of executables or data files. Each rule 1430 consists of a transformation operation 1510, discussed in more detail below. The rules 1430 can be stored in the software repository 1114 of proxy module 1100, and they are loaded to each backend instance 1110 when preparing the environment for a mobile device 30. In an aspect, each transformation rule 1430 consists of three components: a transformation filter, a transformation operation/action, and a transformation configuration.

The transformation filter characterizes a set of UI elements in a page view. The transformation filter is a “regular expression” pattern of attributes used in matching UI elements on which transformations rules can be applied. A transformation filter can be defined to uniquely identify a single UI element or a group of UI elements in a layout type. Such a flexible pattern can include exact match or partial match to one or multiple attributes of the target element, any of its ancestors, and/or any of its descendants in the tree structure of the virtual view. For example, an administrator can use a transformation filter to uniquely identify the “logout” button and move it to the navigation bar, and then use another transformation filter to identify the group of all other buttons and move them to the menu stick at the bottom of a view.

A transformation filter that uniquely identifies an element is defined with a set of attributes that differentiate an element from other elements in a web application. Such attributes of an element remain static and unique in the web application. They are called identifier attributes. The default set of identifier attributes includes nodeName, id, className, name, href, and onclick. The set of identifiers may vary depending on the implementation of web applications. Certain attributes may be removed from the default set if it is not static. For example, id may be generated randomly in each web session, and href may contain session-specific information. Such attributes cause the same element to be identified as different elements in different sessions, and thus are excluded from the filter. Certain attributes may be added if the default set does not differentiate an element from others. For example, nodeValue is used as an identifier attribute for a pure-text element since it does not contain any other identifier attribute.

A transformation filter that identifies a group of elements can be defined with an arbitrary set of attributes extracted from the DOM tree. For example, a filter for “the first column of all tables” can be defined with the index of the column in a row.

Below are examples of flexible transformation filters that are robust against application dynamism: (1) Site links in home page: Any <a> with non-empty text in top link bar with class name “site-navigation”; (2) Image buttons in a site page: Any <a> with class name “module” and contains at least one image element and one text element in its subtree; and (3) External site links in a module page: Any <a> with an URL that doesn't start with “https://documents.example.com/”.

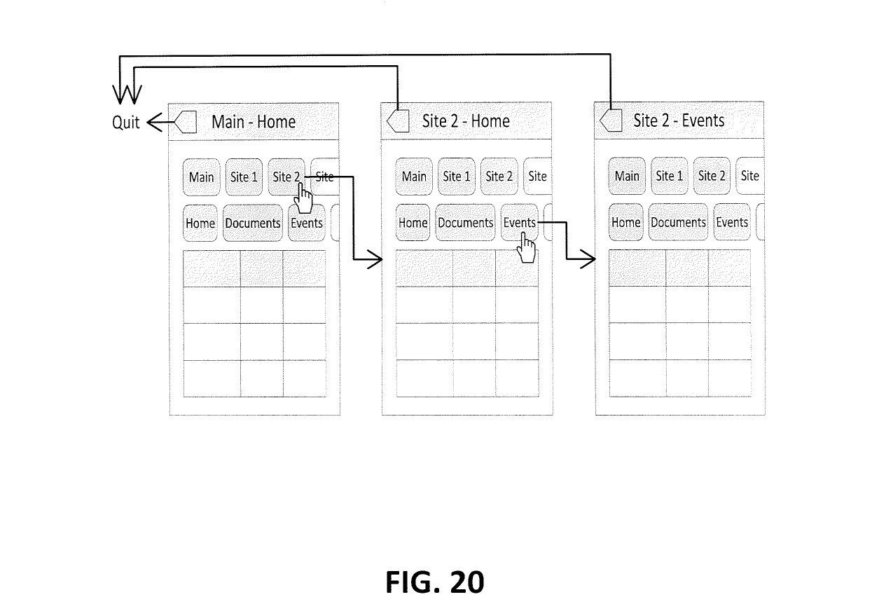

The types of transformation actions/operations dictate the type of transformation operation 1510 that is to be carried out by the transform module 1500 on the UI elements. The types of transformation operations 1510 can vary greatly, and can include, but are not limited to, aggregation, contextualization, federation, focus, overflow, re-arrangement, reduction, re-visualization, traffic suppression, translation, workflow customization, zoom, extend, modify, theme, and the like (some of which are shown in FIG. 19). Some transformation rules can be marked as terminal transformation rules. If an UI element matches the filter of such a rule, no more matching will be done after this rule.

In an aspect, the transformation actions 1510 can be divided into basic transformation actions and composite transformation actions. A basic action describes a single transformation, such as Reduce, that operates on a matched UI element. A composite action operates on a subtree rooted by a matched element. Such a composite action is typically used in transforming composite UI elements. For example, an auto-complete edit box uses a pop-up dialog to show suggestions based on the current input. When such a dialog matches with a filter, all suggestion buttons in the dialog is transformed into an option in the dictionary used by the auto-complete edit box.

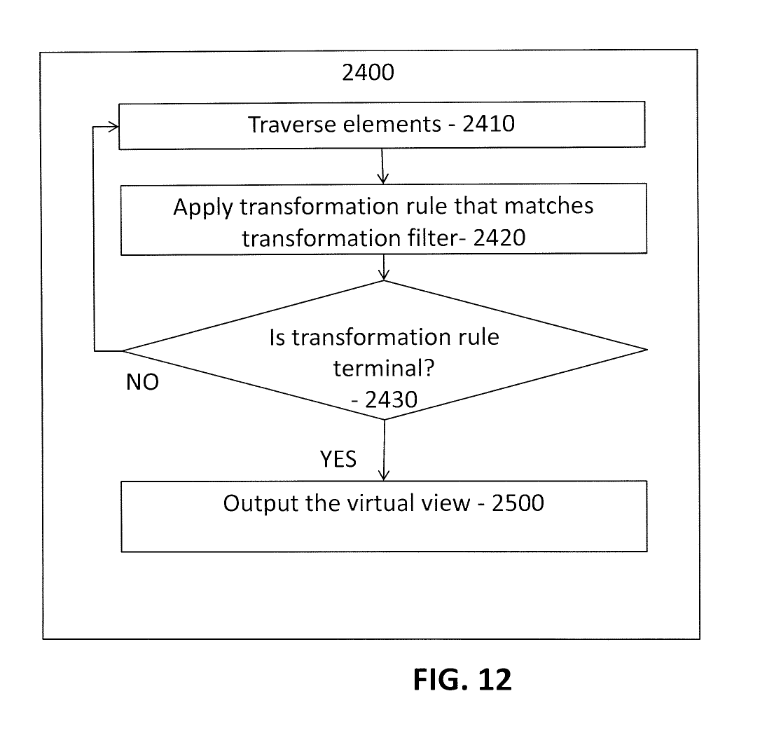

As illustrated in FIG. 11, the transformation application 108 can carry out a transformation method 2000, through the use of the classify module 1400, the transform module 1500, the delivery and render module 1600, the latter two discussed in detail below.

The transformation application 108 can call on the classify module 1400 to match the fingerprints 1410 already on file (stored on the depository 1116 and loaded in the backend instance 1110a) to the input virtual view 1310 provided by the virtualize module 1300, as shown at step 2100. In an aspect, the fingerprints 1410 can be organized in a specific order, and the classify module 1400 can compare the elements/layout of each input virtual view 1310 to the ordered fingerprints 1410. Once a fingerprint 1410 that matches the input virtual view 1310, the corresponding layout type 1420 is then identified (step 2200). After identifying the corresponding layout type 1420, the list of transformation rules 1430 that corresponds to the layout type is retrieved (step 2300).

The transformations operations/actions 1510 dictated by the corresponding set of transformation rules 1430 are then applied to the input virtual view 1310 (step 2400). The transformations 1510 can be carried out by the transform module 1500. Transformations 1510 can be basic, terminal, composite-action, etc., as described in detail below. For a basic transformation action, apply the transformation on the matched virtual element. For a composite transformation action, apply the transformation on the subtree rooted by the matched virtual element. Each transformation 1510 is carried out to each element within the input virtual view 1310. After the transformations have been carried out, the delivery and render module 1600 can then output the virtual view to the mobile device 30 (step 2500).

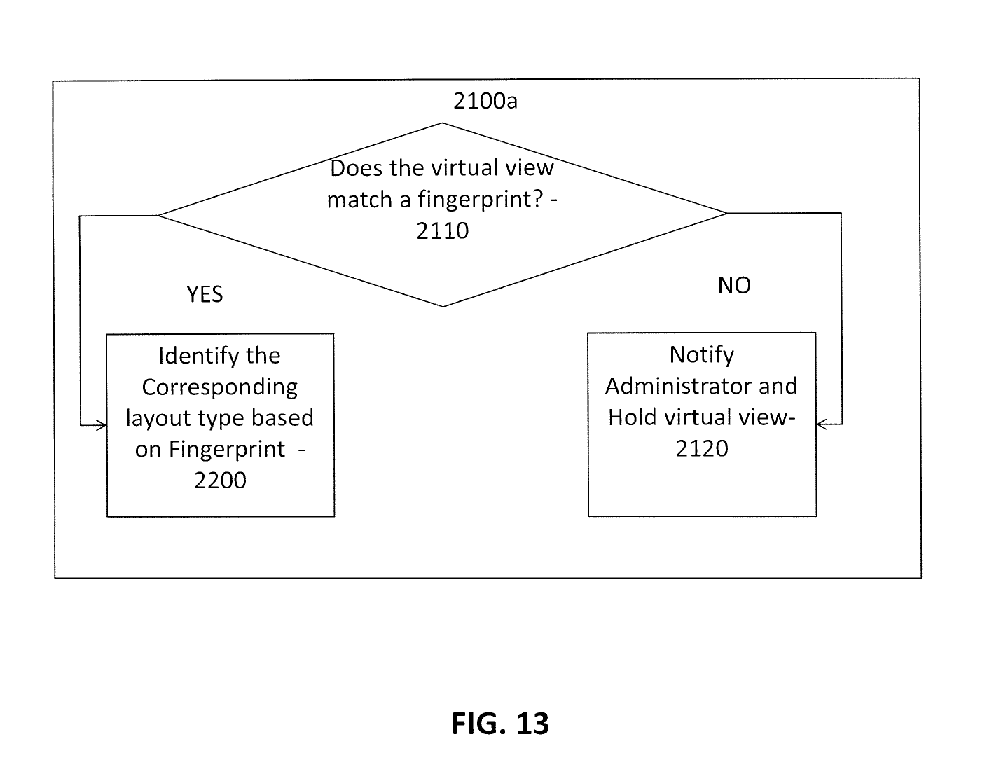

In an aspect of step 2400, as shown in FIG. 12, each element (basic or composite) of virtual view tree can be traversed in post-order, with all child elements processed/transformed before process a parent element in the virtual view, as shown in step 2410. If the element matches the transformation filter of the rule 1430, then the transformation action of the rule 1430 is applied (step 2420). The classify module 1400 will continue to monitor to see if any of the elements match the filter of a terminal transformation rule (step 2430). If the rule is not a terminal rule, the classify module will continue to traverse the elements (2410) and apply the corresponding transformation rules (2420) until a terminal rule is found. When the terminal rule is found, the virtual view is then outputted to the mobile device 30 (step 2500).

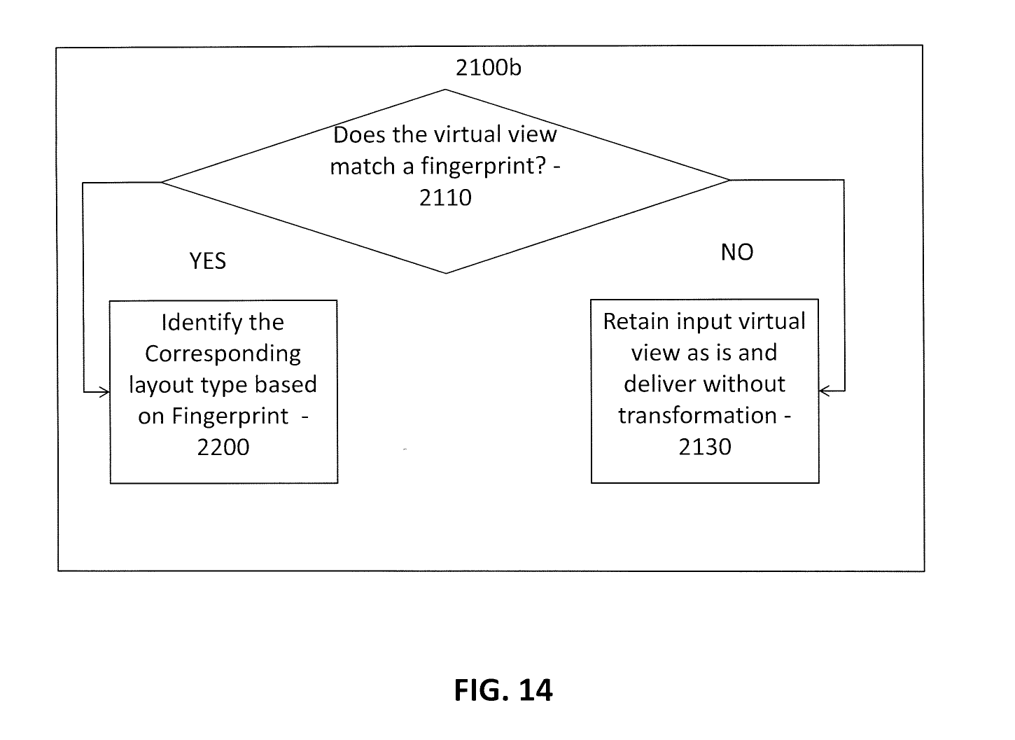

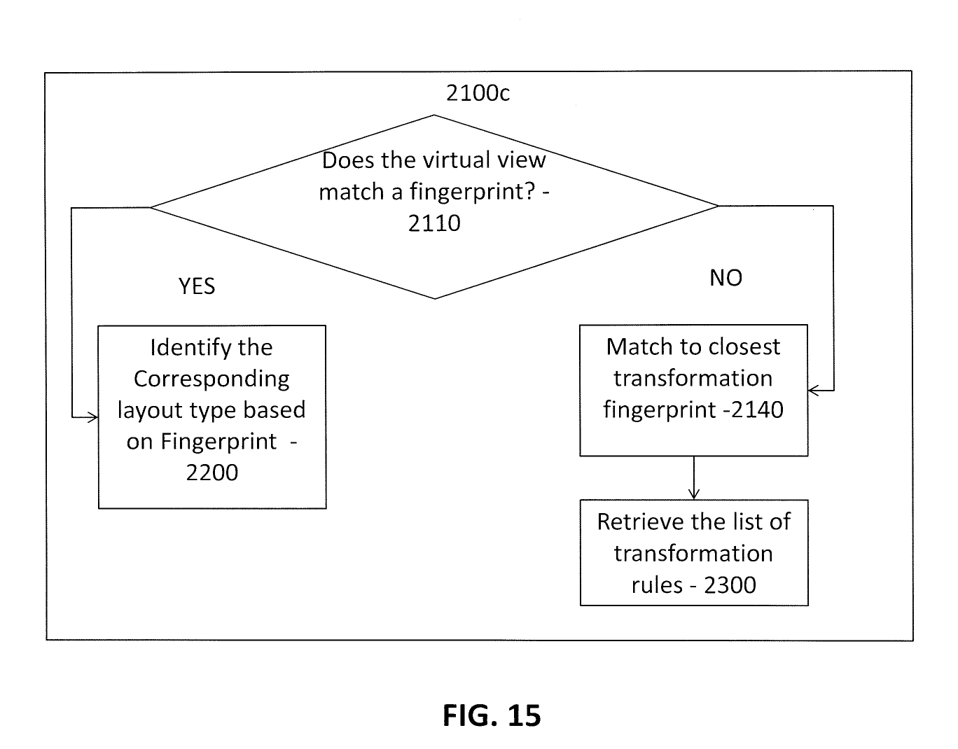

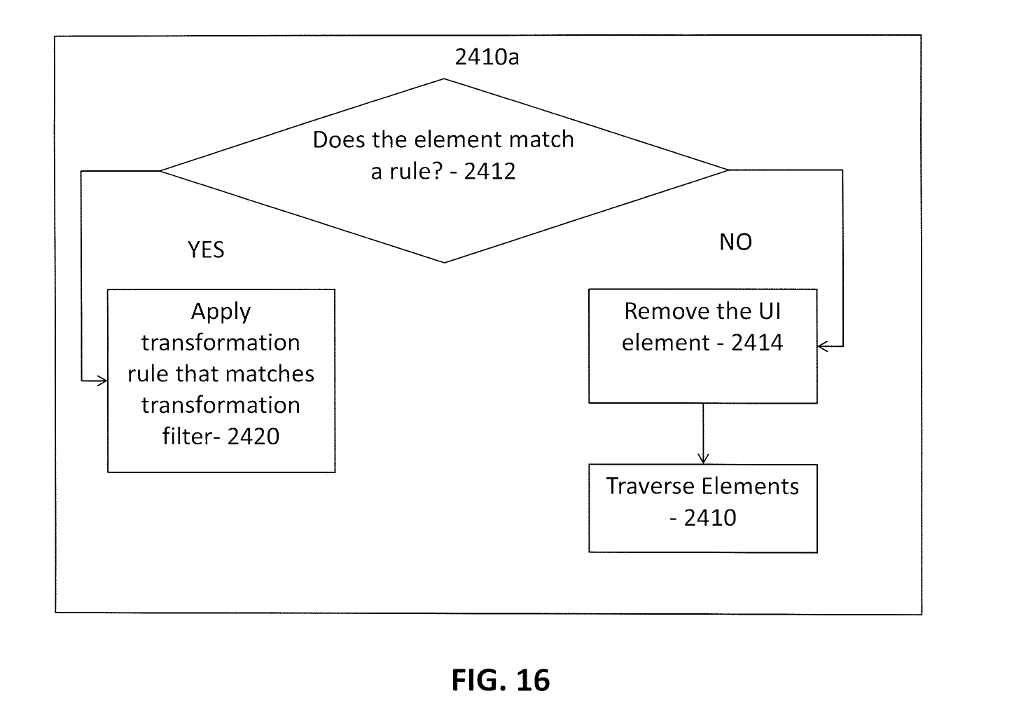

In an aspect, the application 108 can be configured to handle exceptions that can be caused by changes to the enterprise application 22. For example, the application 108 can be configured to handle transformations of the enterprise application 22 when the input virtual view 1310 does not match a given fingerprint 1410. Such instances can occur when the enterprise application 22 has a view with a new layout type 1420. FIGS. 13-15 provide examples of how the application 108 can handle such an exception. If the application determines that the virtual view 1310 does not match an established fingerprint 1410 (step 2110), the application 108: can notify an administrator and hold the virtual view 1310 (step 2120) (as shown in step 2100a of FIG. 13); retain the input virtual view 1310 as is and deliver the view to the mobile application 32 without transformation (step 2130) (as shown in 2100b of FIG. 14); or match the view 1310 to the closest transformation fingerprint 1410 (step 2140) and then retrieve the list of the transformation rules 1430 for the corresponding layout 1420 (step 2300) (as shown in step 2100c of FIG. 15). If the virtual view 1310 does match a given fingerprint 1410 (step 2110), then the corresponding layout type 1420 is identified based on the fingerprint 1410 (step 2200) (FIGS. 13-15).

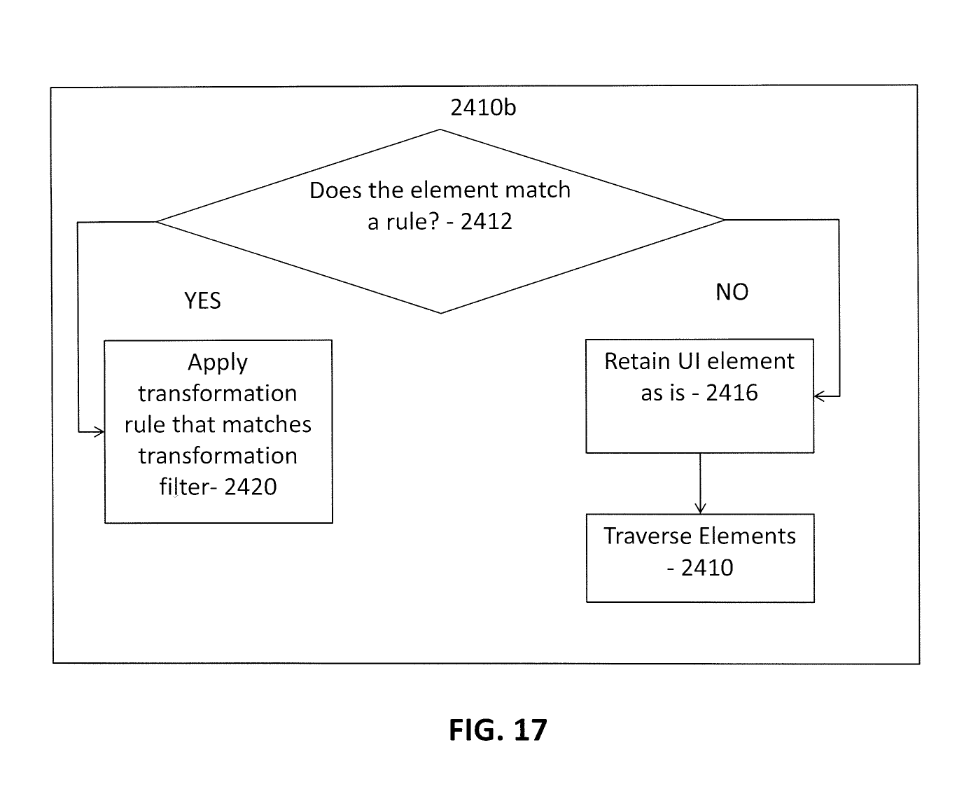

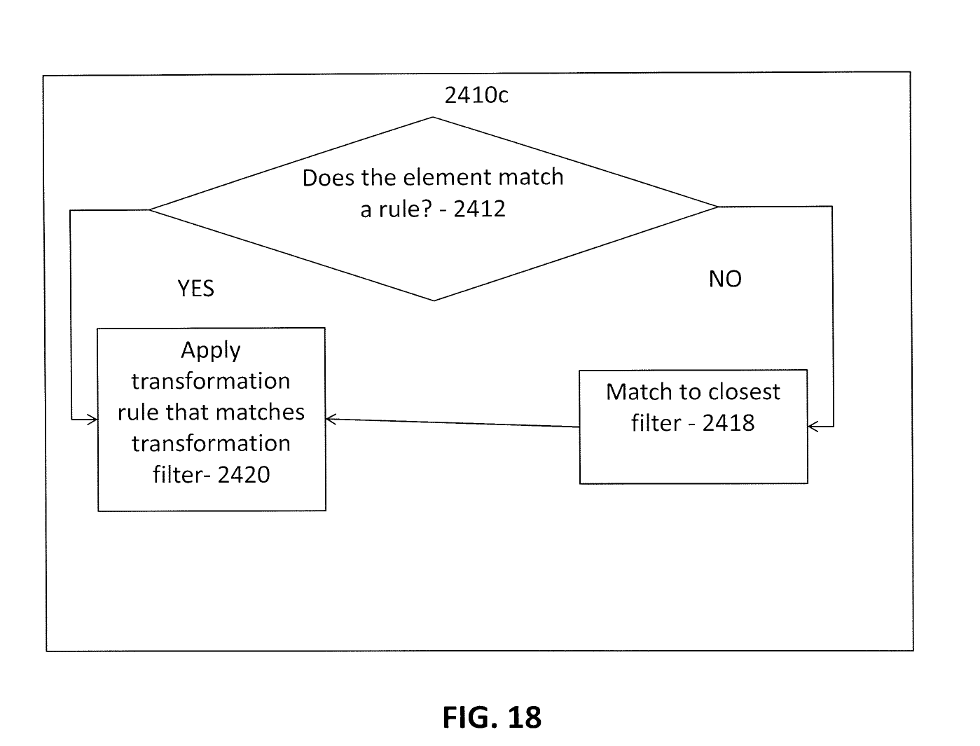

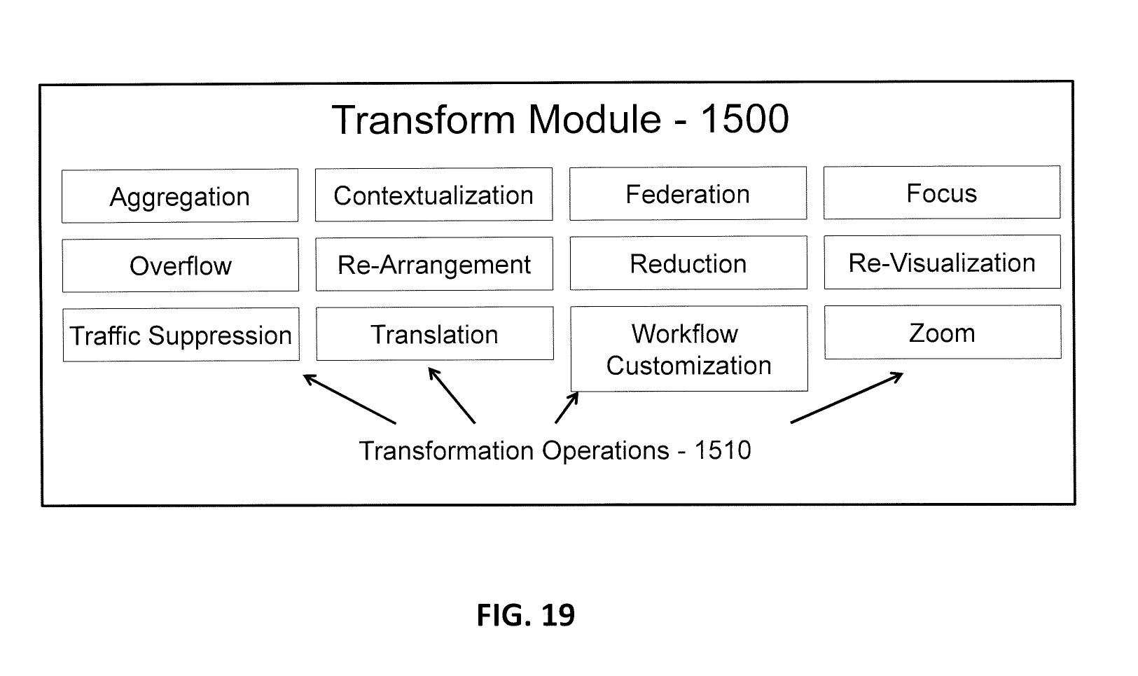

The application 108 can also be configured to handle exceptions when an input virtual view 1310 matches with a defined fingerprint 1410, but contains new UI elements in an existing layout type 1420. In other words, no transformation rule 1430 matches with an UI element. FIGS. 16-18 provide examples of how the application 108 can handle such an exception. If the application 108, while traversing the elements (2410a, b, or c) determines that a UI element does not match a rule 1430 (step 2412), the application 108: can remove the UI element (step 2414) and continue to traverse the elements (step 2410) (as shown in step 2410a of FIG. 16); retain the UI element view as is (step 2416) and traverses the elements (step 2410) (as shown in step 2410b of FIG. 17); or match the UI element to the closest rule filter (step 2418) and apply the matching transformation rule 1430 (step 2420) (as shown in step 2410c of FIG. 18). If the UI element does match a rule 1430 (step 2412), then the application 108 applies the transformation rule 1430 that matches the transformation filter (step 2420) (shown in 2410a, b, and c of FIGS. 16-18 respectively). The above steps can be selected or implemented at the discretion of an administrator. In addition, an administrator can be provided notice of any of the exception events discussed above.

As discussed above, the transform module 1500 can be called upon to implement the transformation actions 1510 associated with each rule 1430 on the input virtual views 1310 to create the mobile application 32. In an aspect, each transformation 1510 performed by the transform module 1500 can be applied separately. In an aspect, when applying each transformation 1510, the virtual view 1310 can be traversed from the root. In another aspect, certain transformation rules 1430, and therefore transformation actions 1510, can be applied using pre-order tree traversal, improving performance by avoiding unnecessary processing, such as traversing a subtree rooted by a node that will be removed by Reduce transformation. In another aspect, pre-processing can be applied to the input virtual view to reduce the computation cost of tree traversal and sequential filter matching.

In an aspect, the transform module 1500 provides a suite of generic transformations 1510 (for example, those shown in FIG. 19) focused on view, activity, and workflow customization that allows for a target application 32 with native mobile UX to be derived from an existing enterprise application 22.

In an aspect, the Translate transformation allows a UI element or a group of UI elements to be converted into a specific virtual element. This allows customization of the derived view when an element in the default view created by the view virtualization process does not carry the expected function. In other words, the element in a view of an enterprise application 22 is not transformed into an element in a view of the mobile application 32 with equivalent capability. For example, an auto-complete edit box in the enterprise application 22 can be transformed into a plain edit box without auto-complete suggestions in the mobile application 32. This is determined by what kind of UI elements exist in an enterprise application 22 and how they are used. It is independent from the mobile device/system 30. Two types of such causes are explained below.

The Translate transformation 1510 is particularly useful in transforming “composite UI elements” in web applications 22 on the enterprise server 20. In web applications 22, the UI, data, and workflow elements are created using standard HTML elements as the basic building blocks. When a single standard HTML element does not provide needed function, multiple standard HTML elements are typically used jointly to form a composite UI element that achieves such function. The Translate transformation 1510 allows such composite UI elements to be converted into an appropriate virtual element that carries the expected function. The examples of composite UI elements include but are not limited to: auto-complete edit box that shows suggestions based on partial input; a button that contains both image and text; a drop-down list which contains options that are created dynamically; a slider control element; and a table that is constructed using individual containers such as HTML div elements.

When an HTML element provides multiple functions, it may not be mapped to the expected virtual element in the default derived view. The Translate transformation 1510 can be used to customize a derived view by configuring the appropriate mapping. For example, an HTML table element can be used to present structured data or simply as a layout container. MORPH virtualizes all HTML table elements into layout containers by default. The Translate transformation 1510 allows mapping of a layout container into a virtual table to provide appropriate data presentation.

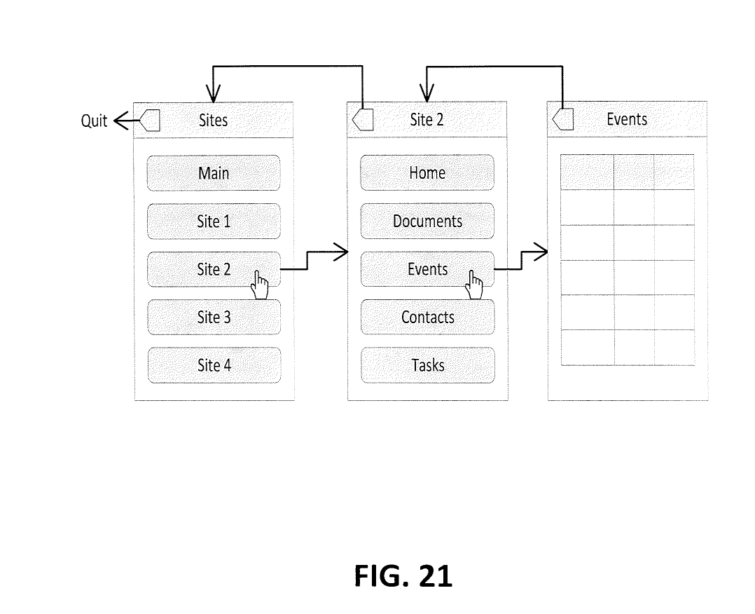

In an aspect, a Focus transformation 1510 allows a view of the mobile application 32 to be derived by shifting the focus area in a workflow of an enterprise application 22. This can be used to derive mobile-friendly workflow when the workflow of the enterprise application 22 contains navigation elements. For example, content management applications 22 such as Microsoft SharePoint contain a top navigation bar for site navigation and a left navigation bar for tool navigation in its default layout. FIG. 20 shows an example of such workflow with navigation elements and the derived mobile workflow without the Focus transformation. FIG. 21 shows a mobile-friendly workflow after applying the Focus transformation. While using navigation tool bar as an example, the Focus transformation is capable to be applied to general UI elements. Besides, an UI element can be configured to appear in both a focused area and the main area to facilitate quick access to the UI element from different stages in the workflow.

The Extend transformation allows a workflow in a PC application to be extended into a mobile-friendly workflow. This allows configuration of an UI or data element in a derived view to be linked to an external process that can consume such UI or data element. The examples of such extension include but are not limited to: opening a downloaded document file to a document viewer; opening a downloaded image file to an image viewer; opening a video resource in a video viewer; opening a web site URL in a browser; using a phone number to initiate a phone call; using an email address to create an email in an email client; using an address to query the location in a map client; and attaching a downloaded file to an email in an email client.

The Contextualize transformation makes a derived app context-aware by providing input parameter values to an existing PC application based on the user's context. PC applications are built without the awareness of contextual information of the user, since the context of application usage typically remain static. When the application 108 delivers a derived app to a mobile device 30, contextual information available at the mobile device can be leveraged to make the derived app more mobile-friendly.

For example, location is contextual information that can be used to make search more accurate when looking for nearby resources. The Contextualize transformation can be realized with a generic solution in interfacing different types of contextual information with different types of input parameters. The application 108 can leverage the contextual information that can be acquired from a smartphone. Each piece of contextual information is called a contextual hook. Contextual hooks that can be provided in the application 108 include location, proximity, time, and ambient voice. The application 108 maintains the history of input parameter values and the contextual hooks.

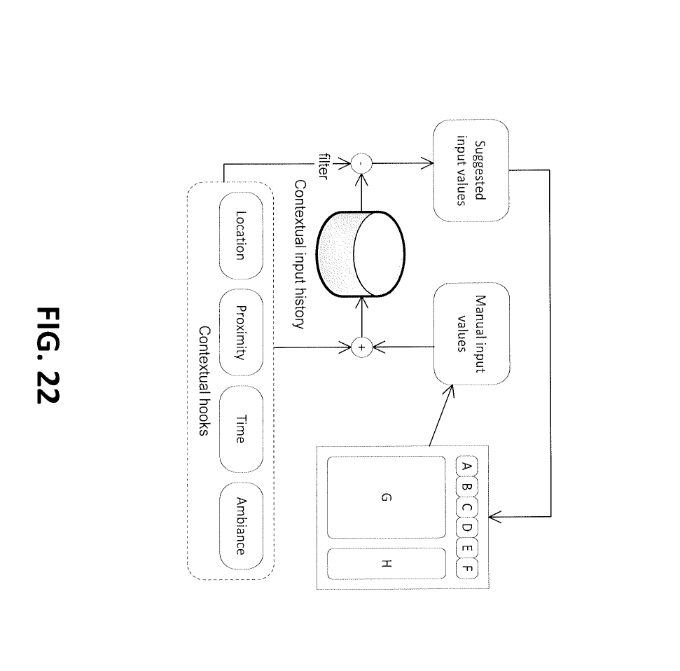

Whenever a user wants to provide an input parameter value, the application 108 allows the user to pick a contextual hook to get the suggested values from the history that are most relevant to the current contextual hook. For example, when a user wants to print a document to a printer nearby, he or she can pick the location hook while selecting a printer in printing the document, the application 108 will show the list of printers sorted by the distance between the recorded location and the user's current location. The location can be geometric location or logical location based on sensory data available at a smartphone, such as the list of available WiFi APs. Other examples of the contextualization service include: (1) a user attending a meeting can look up emails sent by any members in same meeting using the proximity hook; (2) a user can edit or send a recently opened document using the time hook; and (3) a user in a conversation can to look up the definition of jargons used by others using the ambient voice hook. FIG. 22 illustrates different components of the Contextualize transformation.

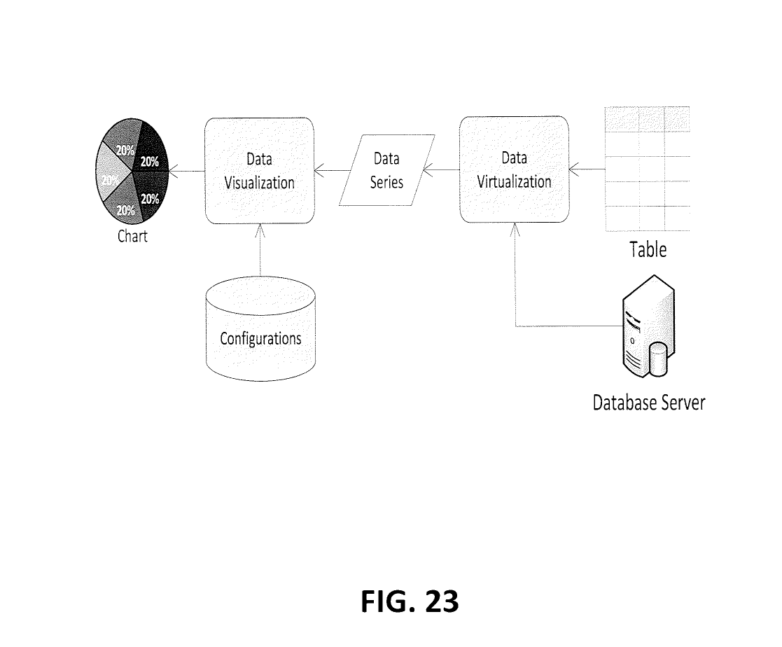

The Re-Visualize transformation can be used to create customer configured graphs and charts for the data present in the tables. In the PC/Web application, a table could be sufficient to consume huge amounts of data because a PC has a huge physical screen where the user will be able to see multiple rows and columns at the same time. On a mobile device, the screen real estate may not be sufficient for the same data consumption. Further, the use case scenarios on a mobile device might need easy consumption of huge amounts of data. Also, the PC/Web application could be a legacy application and new data visualizations are required for the mobile view. Using this service the user can manually configure creation of graphs and charts such as pie charts, bar charts, histograms, scatter plots, line plots, curve fit plots etc. These configured graphs and charts can be dynamically updated with any data changes made to the data table as long as the columns of the table are not modified. The data elements extracted from the PC application are first virtualized into structured data series, and then the data series are visualized into charts based on the configurations. FIG. 23 illustrates the idea of the Re-Visualize transformation. While using extracted table elements as an example, the Re-Visualize transformation can be applied to general data source. The application 108 can be extended with the capability of fetching data from other databases maintained by the enterprise and present graphs and charts based on the data.

The Modify transformation allows customization of a virtual element in the derived mobile view by modifying one or multiple of its attributes. The attributes that can be modified include but are not limited to: label text; text color; background color; icon or image; size; alignment; and orientation of a container.

The application 108 can provide other transformations, including, but not limited to, the following:
Reduce: Showing only a subset of the UI elements that the user wants to access from the mobile device.
Rearrange: Allowing configuration of the placement of UI elements in the mobile view.
Federate: Combining UI elements from two or more applications into a single mash-up view.
Overflow: Intelligently splits a view into multiple views to suit the form factor of a mobile device.
Zoom: Allowing on-demand run-time adjustment of the set of UI elements visible in the derived app.
Aggregate: Allows aggregation of actions for routine tasks into programmable macros and invocation of such macros in run time, as described in PCT/US2011/064469 Entitled “Systems and Methods for Providing Programmable Macros”, hereby incorporated in its entirety by this reference.
Theme: Allows customization of look-and-feel for an entire app or a group of views.

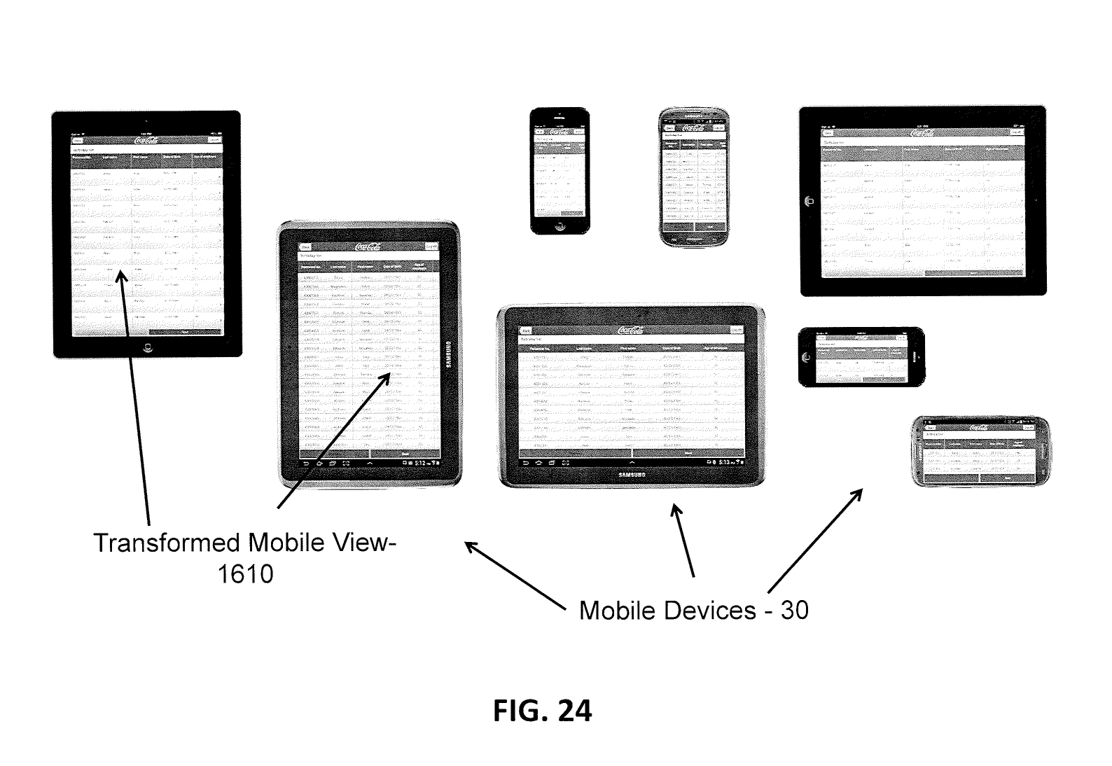

The application 108 calls upon the deliver and render module 1600 to deliver the various transformed mobile views 1610 to the mobile application 32. In an aspect, the deliver and render module 1600 delivers the derived application 32 in terms of transformed mobile views 1610 using on mobile platforms (determined by the mobile device 30) as structured objects using a device-independent format with real-time push of updates. Then, the deliver and render module 1600 renders each virtual element with a native UI element in the mobile platform. The deliver and render module 1600 supports screen-independent rendering that automatically adapts to different screen densities, different screen sizes, and different configuration (such as orientation). FIG. 24 shows examples of the deliver and render module 1600 rendering the same transformed mobile view 1610 in different devices and configurations.

In an aspect, the deliver and render module 1600 can be a native client built on any of the supported mobile platforms, which include but are not limited to iOS, Android, Windows Phone, BlackBerry, etc. The native client is installed in a mobile device. In run time, the native client directly gets virtual view updates pushed by the backend server and renders each virtual view at the frontend.

In an aspect, the deliver and render module 1600 is an HTML5 client built with AJAX. The HTML5 AJAX client is loaded from the system 10 when launched for the first time. Once the HTML5 AJAX is loaded in a mobile browser, it directly gets virtual view updates pushed by the backend server and renders each virtual view in the mobile browser.

In an aspect, the deliver and render module 1600 is an HTML5 client built without AJAX, which is called HTML5 classic client here. The HTML5 classic client has all or most of its presentation logic resides at a web server. The web server gets virtual view updates pushed by the backend server and renders each virtual view into a HTML document. Then, the HTML5 classic client renders each of those HTML documents in a mobile browser.

In another aspect, the deliver and render module 1600 client is a hybrid client built with combination of above technologies.

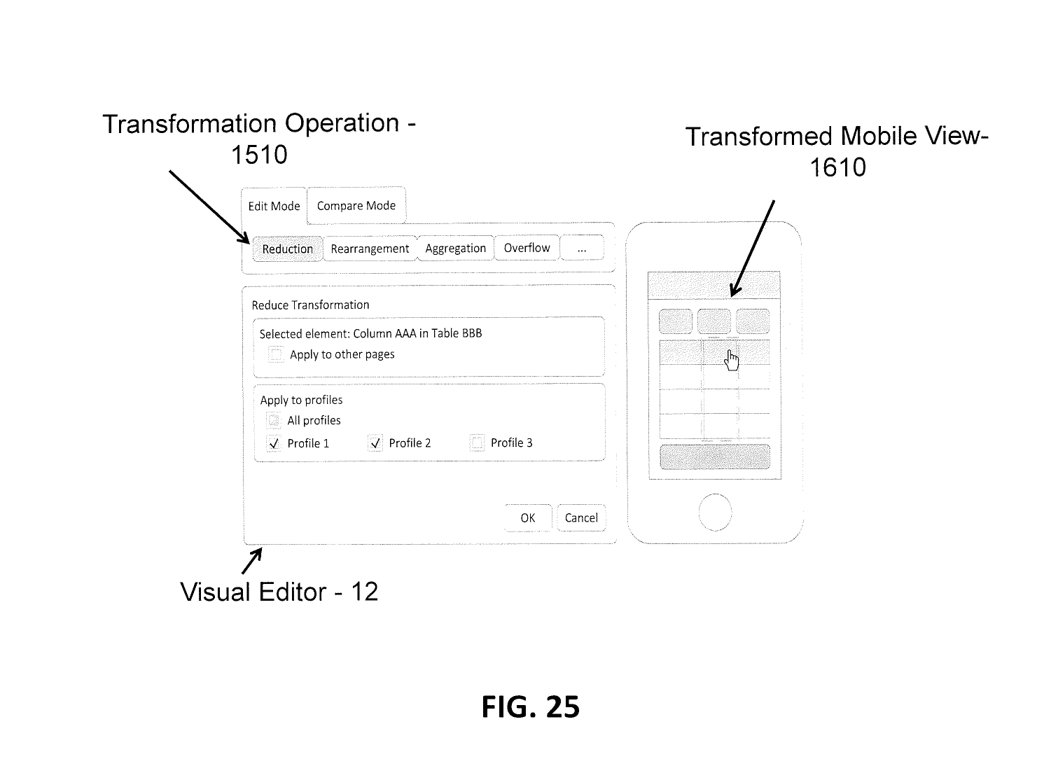

In another aspect, the specify module 1700 of the application 108 provides a visual tool or method to an IT admin in charge of deriving a mobile app from a PC application. In configuration phase, the specify module 1700 is used jointly with other components of application 108 to enable the admin to configure how an existing PC application should be transformed into a derived mobile app. While we describe the specification process with a “What You See Is What You Get” (“WYSIWYG”) visual editor 12, as shown in FIG. 25. The visual editor 12 can be utilized by an administrator to configure the various transformation rules 1430 (and corresponding transformation actions 1510) for the layout types 1420 that match the given fingerprints 1410. The process can be replaced or assisted by a manual coding process.

In an exemplary aspect, the specification of each transformation rule consists of following basic steps:

1. Fingerprint: An input view is first matched to layout types that have been configured. If it matches with a layout type fingerprint, transformation rules are applied and the admin can edit based on the existing rules. If the view doesn't match with any fingerprint or is matched to a wrong one, the admin creates a new fingerprint and define the associated layout type.

2. Inspect: The admin inspects the application view, which can be any combination of the following forms:
The application view of the existing PC application.
The extracted application view. This can be done by a third-party tool such as DOM tree inspection in web browsers for web applications and InspectObject for .NET applications.
The input virtual view.
The output derived view.
The rendering view in a mobile platform (as shown in FIG. 25).

3. Identify: The admin identifies the set of UI elements that need to be transformed in the current view.

4. Filter: A filter is created to capture the identified UI elements. The filter may be created automatically by the visual editor or manually by the admin.

5. Configure: The admin creates a transformation rule by specifying the transformation actions and transformation configurations to apply to the matched UI elements.

6. Store: The admin stores the transformation rule as a form of persistent storage (file or database) through visual editor, or as program code through manual coding.

7. Verify: The admin verifies the transformation rule by applying it to the application view and reviewing the mobile view. As shown in FIG. 26, the admin can compare a view of the enterprise application 22 as it would be seen on the enterprise server 20 and the derived/transformed mobile view 1610 in the visual editor 12.

In an aspect, as discussed above, the optimization module 1800 allows several optimizations to the transformations performed by the transform module 1500. The optimizations enhance system 10 by reducing the network payload, or reducing the time taken by the system 10 in dynamically mobilizing the application in real-time. There are two optimizations that the MORPH protocol currently supports.

The Collapse Virtual View optimization reduces redundant layers in a virtual view. As explained before the virtual view consists of a tree structure with a root node containing container and/or leaf nodes. Container nodes can in turn contain more container and/or leaf nodes. Virtualizing a web-based application's UI from the DOM tree creates a number of redundant layers of containers in the virtual view. Virtualizations of applications other than web-applications can also contain redundant layers of containers. The Collapse optimization forces a pre-determined number of maximum layers of containers in the virtual view. The collapse optimization can be performed on the virtual view produced by the Virtualization component or on the transformed virtual view output of any other transformation service described in Section 6. As a result of this optimization the virtual view becomes simple for the mobile client to render the mobilized UI and also the network payload for the communication between the proxy and the mobile client is reduced. Further, a collapsed virtual view input may be easy to process by some of the transformation services because of the smaller and simpler footprint.

The Transformation Caching transformation service essentially converts an input virtual view in to a modified output virtual view. A given input virtual view will always result in the same output virtual view if the application state is the same. Thus we can cache the output virtual views and use the cached output virtual views if we require transforming the same input virtual view under same application state conditions. This optimization is referred to as Transformation Caching. In order to apply this optimization we need to have a mechanism to compare a given input virtual view with a history of known input virtual views whose output virtual views have been cached.

In an aspect, the optimization module 1800 can provide for the following additional optimizations:
Instance selection: Allows the selection of the backend instance type depending on the latency and performance requirements of the application. For example, the Amazon EC2 offering allows for the selection of instance types all the way from micro-instances to extra-large instances with varying memory and CPU capabilities. MORPH intelligently selects the type of instance required for an application based on either configured settings or past performance history.
Backend location: Provides better performance may be achieved (subject to deployability) by locating the backend directly on or adjacent to the application server, or directly on the mobile device. This would considerably improve the network latencies associated with having a third leg in the end-to-end path.
Headless browser—traditional browsers like Chrome, Firefox, Internet Explorer, etc., have a rendering process at the end of their sequence of steps when processing any web content. Since the MORPH protocol deals directly with the DOM tree, significant performance improvements could be achieved by disabling the graphical rendering of the DOM tree.

Having thus described exemplary embodiments of the present invention, those skilled in the art will appreciate that the within disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A method for converting a non-mobile application view to a mobile application view for use on a mobile device, the non-mobile application view comprising a plurality of non-mobile view elements, comprising:
a. generating a plurality of classifications of non-mobile application views, based on their at least one constituent element;
b. generating a plurality of transformation filters, each of the plurality of transformation filters being associated with one of the plurality of classifications;
c. selecting one of the plurality of non-mobile view elements;
d. identifying a selected one of the plurality of classifications as matching the selected non-mobile view element; and
e. applying a selected one of the plurality of transformation filters associated with the selected classification to the selected non-mobile view element, to generate a transformed element.

2. A method for classifying a non-mobile computer platform application view for converting it to a mobile application view for use on a mobile device, comprising:
a. creating classifications of non-mobile computer platform application views using a flexible combination of their constituent elements;
b. matching a non-mobile computer platform application view a classification and a set of transformation filters;
c. matching constituent elements to transformation filters;
d. applying transformations that change part or full of the application view.

3. A method for extracting and operating application views from a non-mobile computer platform application, comprising:
a. extracting constituent elements from the application;
b. operating constituent elements in the application; and
c. operating functions in the application through the platform.
